(19) United States
(12) Patent Application Publication
(10) Pub. No.: US 2026/0193151 A1
(43) Pub. Date: Jul. 9, 2026

(54) LID ASSEMBLY SYSTEM FOR COMPOSTER

(71) Applicant: VCycene Inc., Markham (CA)

(72) Inventors: Huayi Gao, Markham (CA); Xiangdong Yin, King City (CA); Janusz Wielgosz, Toronto (CA); Ming Lam Timothy To, Scarborough (CA); Junaid Ahmed Siddiqui, Scarborough (CA)

(21) Appl. No.: 19/440,856

(22) Filed: Jan. 6, 2026

Related U.S. Application Data
(60) Provisional application No. 63/742,299, filed on Jan. 6, 2025.

(51) Int. Cl. C05F 17/964; C05F 17/70; C05F 17/993

(52) U.S. Cl. CPC C05F 17/964; C05F 17/70; C05F 17/993

(57) ABSTRACT

Various embodiments are described herein for an apparatus for producing compost. The apparatus or composter assembly may include a dual lid system. The dual lid system can include a first lid configured to allow waste to enter a crushing assembly before being transferred to a composting assembly; a second lid configured to allow waste to bypass the crushing assembly and enter the composting assembly directly; and a control unit configured to receive input from a user or an algorithm to determine which of the first or second lids should be opened based on the type of waste being processed.

### INCORPORATION BY REFERENCE

This application claims priority from U.S. Provisional Patent Application No. 63/742,299 filed Jan. 6, 2025; the entire contents of which is hereby incorporated herein by reference in its entirety.

### FIELD

The various embodiments described herein generally relate to systems and methods for generating organic compost from waste such as, but not limited to, food remains, as well as paper products, cardboard products, and/or some plastics.

### BACKGROUND

The following paragraphs are provided by way of background to the present disclosure. They are not, however, an admission that anything discussed therein is prior art or part of the knowledge of persons skilled in the art.

Composting is the natural process of recycling organic matter, such as leaves and food scraps, into compost that can be used to enrich soil and plants. All organic discards decompose eventually however, composting can be used to speed up the process by providing an ideal environment for composting to occur. In simple composters, ideal humidity and temperature conditions can be maintained to complete the composting process. In some more complex composters, decomposing organisms (such as bacteria, fungi, worms, sowbugs, and/or nematodes) may be used to compost the organic matter. In other composters, chemicals may be used to compost the organic matter.

Organic discards can be processed in industrial-scale composting facilities, in smaller-scale community composting systems, in anaerobic digesters, and in home composters, among other options.

A drawback of small-scale composting systems is that it is difficult to obtain a sizeable volume of compost as only a small number of organic materials are produced in a given period. For instance, if a user deposits a small amount of organic material into a composter at one time, the amount of useable output compost may only be a fraction of the original deposited volume. In this example, the user may have to continuously deposit a small amount of organic material resulting in a continuous amount of compost, which is why this process is called continuous composting. Continuous composting may not be used to process newly added scraps while waste is currently being composted as it may require a long amount of time to process waste and so any newly added scraps will not have been digested (typically requiring 3 months under common conditions) and will pollute previously digested compost resulting in an un-finished mixture.

In order to avoid generating small amounts of compost, users typically have to collect food scraps for longer periods of time before inputting the larger volume of scraps into the composter, which is why this process is known as batch composting. However, batch composting requires users to collect and store decomposing organic matter, prior to composting, which may produce odors and other allergens such as mold and dust which can cause discomfort in the home or outdoor spaces.

### SUMMARY OF VARIOUS EMBODIMENTS

In one aspect, in at least one embodiment described herein, there is provided a dual lid system for a composting device, comprising: a first lid coupled to a first passageway including a crushing assembly, the first lid being configured to move to an open position to allow incoming waste to enter a crushing hopper assembly of the composting device before being transferred to a compost chamber of the composting device; a second lid coupled to a second passageway to bypass the crushing assembly, the second lid being configured to move to an open position and allow the incoming waste to bypass the crushing assembly and enter the composting chamber directly; a control unit configured to receive a user input from a user or execute a waste detection algorithm to determine which of the first or second lids to open based on a waste type of incoming waste to be processed.

In at least one embodiment, the control unit comprises a processor that is communicatively coupled to a memory that stores the waste detection algorithm, wherein the processor is configured to execute the waste detection algorithm to analyze sensor data for the incoming waste to determine one or more characteristics of the incoming waste to determine the waste type which of the first and second lids to open.

In at least one embodiment, one or more sensors are included in the dual lid system or are external to the dual lid system, the one or more sensors being operated to obtain the sensor data.

In at least one embodiment, the crushing assembly is configured to reduce a size of the incoming waste for faster composting when the first lid is selected.

In at least one embodiment, the processor is configured to determine a hardness characteristic of the incoming waste, and generate a control signal to actuate the first lid if the hardness characteristic is higher than a threshold value or actuate the second lid if the hardness characteristic is lower than the threshold value.

In at least one embodiment, the sensor data includes any combination of a fill level of the compost chamber, a state of the first lid, a state of a second lid, waste-specific characteristics including any of size, type of incoming waste, moisture content, a weight of the incoming waste, a mass/amount of the incoming waste, a hardness of the incoming waste, and one or more characteristics of existing compost in the compost chamber.

In at least one embodiment, when the processor is executing the waste detection algorithm, the processor is configured to use image recognition, weight data from one or more weight sensors or other data points to determine the waste type and determine whether the input waste requires crushing before composting.

In at least one embodiment, the system further includes at least one sensor to obtain data on a state of the existing compost in the compost chamber which is used as feedback to the control unit on effectiveness of the crushing.

In at least one embodiment, the system further comprises a user interface that receives the user input to allow the user to manually select which of the first and second lids to open based on the waste type.

In at least one embodiment, the system further includes sealing elements/mechanisms to prevent odors from escaping the first and/or second lids during operation.

In at least one embodiment, the sealing elements/mechanism provide an airtight seal and optionally include an antibacterial or odor killing component to reduce odors to prevent odor leakage.

In at least one embodiment, the first and second lids and/or the sealing element/mechanism are implemented to reduce moisture escape from the composting apparatus.

In at least one embodiment, the first and/or second lid is implemented as a condenser to return water droplets back to the crushing assembly and/or compost chamber.

In at least one embodiment, the control unit is further configured to adjust the operation of the composting assembly based on whether the input waste was processed through the crushing assembly or directly entered the composting assembly.

In at least one embodiment, multiple (more than two) lids can be implemented to allow input waste to enter into multiple chambers with specific conditions to produce compost or other outputs with value.

In one aspect, in at least one embodiment described herein, there is provided a composting apparatus comprising: a dual lid system as defined according to any one of the previous embodiments, a crushing assembly; and a compost chamber.

In one aspect, in at least one embodiment described herein, there is provided a method of composting incoming waste by a composting device, the method comprising: selectively operating a first lid that is coupled to a first passageway including a crushing assembly, the first lid being operated to move to an open position to allow the incoming waste to enter a crushing hopper assembly of the composting device before being transferred to a compost chamber of the composting device; selectively operating a second lid that is coupled to a second passageway to bypass the crushing assembly, the second lid being operated to move to an open position and allow the incoming waste to bypass the crushing assembly and enter the composting chamber directly; and generating a control signal using a control unit for operating the first and second lids, wherein the control signal is generated based on a user input from a user or from execution of a waste detection algorithm that selects which of the first or second lids to open based on a waste type of incoming waste to be processed.

In at least one embodiment, the control unit comprises a processor that is communicatively coupled to a memory that stores the waste detection algorithm. In at least one embodiment, the method uses the processor to: execute the waste detection algorithm to analyze sensor data for the incoming waste to determine one or more characteristics of the incoming waste; and determine which of the first and second lids to open based on the waste type.

In at least one embodiment, the method further comprises obtaining sensor data from one or more sensors located in the dual lid system or are located external to the dual lid system.

In at least one embodiment, the method further comprises reducing the size of the incoming waste via the crushing assembly for faster composting when the first lid is selected.

In at least one embodiment, the method further comprises determining, by the processor, a hardness characteristic of the incoming waste; generating, by the processor, the control signal based on the hardness characteristic; and actuating the first lid if the hardness characteristic is higher than a threshold value or, actuating the second lid if the hardness characteristic is lower than the threshold value.

In at least one embodiment, the sensor data includes any combination of a fill level of the compost chamber, a state of the first lid, a state of a second lid, waste-specific characteristics including any of size, type of incoming waste, moisture content, a weight of the incoming waste, a mass/amount of the incoming waste, a hardness of the incoming waste, and one or more characteristics of existing compost in the compost chamber.

In at least one embodiment, the method further comprises, when the processor is executing the waste detection algorithm, using image recognition and/or weight data from one or more weight sensors or other data points to determine the waste type and determine whether the input waste requires crushing before composting.

In at least one embodiment, the method further comprises obtaining data, via at least one sensor, on a state of the existing compost in the compost chamber which is used as feedback to the control unit on effectiveness of the crushing.

In at least one embodiment, the method further comprises receiving, by a user device, the user input to allow the user to manually select which of the first and second lids to open based on waste type.

In at least one embodiment, the method further comprises using sealing elements/mechanisms, for the first and/or second lids during operation to prevent odors from escaping the composting apparatus during operation.

In at least one embodiment, the method further comprises providing an airtight seal and optionally including an antibacterial or odor killing component to reduce odors to prevent odor leakage via the sealing elements/mechanism.

In at least one embodiment, the method further comprises reducing moisture escaping from the composting apparatus by using the first and second lids and/or the sealing element/mechanism.

In at least one embodiment, the method further comprises implementing the first and/or second lid to act as a condenser to return water droplets back to the crushing assembly and/or compost chamber.

In one aspect, in at least one embodiment described herein, there is provided a dual lid system for a composting device, comprising: a first lid configured to allow waste to enter a crushing assembly before being transferred to a composting assembly; a second lid configured to allow waste to bypass the crushing assembly and enter the composting assembly directly; and a control unit configured to receive input from a user or an algorithm to determine which of the first or second lids should be opened based on the type of waste being processed.

In at least one embodiment, the control unit is equipped with a waste detection algorithm that analyzes waste type via sensors and automatically opens the appropriate lid.

In at least one embodiment, the crushing assembly is configured to reduce the size of the waste for faster composting when the first lid is selected.

In at least one embodiment, the processor determines a hardness characteristic of the input waste, and actuates the first lid if the hardness characteristic is higher than a threshold value; or actuates the second lid if the hardness characteristic is lower than the threshold value.

In at least one embodiment, the dual lid system further comprises a user interface that allows the user to manually select which lid to open based on the type of waste.

In at least one embodiment, the waste detection algorithm uses image recognition, weight sensors, or other data points to classify the waste and determine whether the input waste requires crushing before composting.

In at least one embodiment, the system further includes sensors that monitor the state of the waste in the composting assembly and provide feedback to the control unit on the effectiveness of crushing.

In at least one embodiment, the first and second lids are equipped with sealing mechanisms to prevent odors from escaping during operation.

In at least one embodiment, the control unit is further configured to adjust the operation of the composting assembly based on whether the waste was processed through the crushing assembly or directly entered the composting assembly.

In at least one embodiment, the crushing assembly can be bypassed manually or automatically depending on the waste input, further optimizing energy consumption by only activating the crushing assembly when necessary.

Other features and advantages of the present application will become apparent from the following detailed description taken together with the accompanying drawings. It should be understood, however, that the detailed description and the specific examples, while indicating preferred embodiments of the application, are given by way of illustration only, since changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a block diagram of a composter assembly according to an example embodiment;

FIG. 1B is a block diagram of a composter assembly according to another example embodiment;

FIG. 1C is a block diagram of a composter assembly according to yet another example embodiment;

FIG. 2A is a block diagram of a composter assembly according to another example embodiment;

FIG. 2B is a block diagram of a composter assembly according to another example embodiment;

FIG. 3 is a left-side view of the composter assembly according to an example embodiment;

FIG. 4A is a front view of a composter assembly shown in FIG. 3;

FIG. 4B is a rear view of the composter assembly shown in FIG. 3;

FIG. 5 is a top plan view of the composter assembly shown in FIG. 3;

FIG. 6 is a bottom plan view of the composter assembly shown in FIG. 3;

FIG. 7 is a front perspective view of the composter assembly shown in FIG. 3;

FIG. 8 is a front perspective view of a composter assembly shown in FIG. 3, showing an open configuration of the first lid of the composter assembly;

FIG. 9 is a top-perspective view of the composter assembly shown in FIG. 3, shown in an open configuration of the first lid, according to an example embodiment;

FIG. 10 is a front perspective view of a composter assembly shown in FIG. 3, showing an open configuration of the second lid of the composter assembly;

FIG. 11 is a rear perspective view of a composter assembly shown in FIG. 3, showing an open configuration of the top hatch;

FIG. 12 is a front perspective view of the composter assembly shown in FIG. 3, shown in an open configuration of the top hatch, according to an example embodiment;

FIG. 13 is a top perspective view of the composter assembly shown in FIG. 3, shown in an open configuration of the top hatch, according to an example embodiment;

FIG. 14 is a top perspective view of the composter assembly shown in FIG. 3, shown in an open configuration of the top hatch, according to an example embodiment;

FIG. 15 is a top plan view of the composter assembly shown in FIG. 3, shown in an open configuration of the top hatch, according to an example embodiment;

FIG. 16 is a left-side view of the composter assembly showing an open configuration of the second lid, according to another example embodiment.

FIG. 17 is a left rear-perspective view of the composter assembly shown in FIG. 16, showing an open configuration of the second lid, according to an example embodiment;

FIG. 18 is a top-plan view of the composter assembly shown in FIG. 16, showing an open configuration of the second lid, according to an example embodiment;

FIG. 19 is a left-side cross-sectional view of the composter assembly shown in FIG. 16, showing an open configuration of the second lid, according to an example embodiment;

FIG. 20 is a left-side cross-sectional view of the composter assembly shown in FIG. 16, showing an open configuration of the first lid, according to an example embodiment;

FIG. 21 is a top rear-perspective view of a composter assembly shown in FIG. 16, showing an open configuration of a first lid;

FIG. 22 is a top front-perspective view of a composter assembly shown in FIG. 16, showing an open configuration of a first lid; and

FIG. 23 is a top-plan view of the composter assembly shown in FIG. 16, showing an open configuration of a first lid.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled”, or “coupling” as used herein can have several different meanings depending in the context in which these terms are used. For example, the terms coupled, or coupling can have a mechanical, electrical or fluidic connotation. For example, as used herein, the terms coupled or coupling can indicate that two elements or devices can be directly connected to one another or connected to one another through one or more intermediate elements or devices via an electrical signal, electrical connection, fluidic pathway or a mechanical element depending on the particular context.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any operable combination thereof. Accordingly, the term “any combination thereof” is meant to cover any operable combination of the elements which precede the phrase. For example, the phrases “A, B, C, D or any combination thereof” or “any combination of A, B, C or D” is meant to include A; B; C; D; A and B; A and C; A and D; B and C; B and D; C and D; A, B and C; A, B and D; A, C and D; B, C and D as well as A, B, C and D assuming that all such combinations are operable (i.e., they can be used together in practice in a working embodiment).

It should be noted that terms of degree such as "substantially", "about" and "approximately" as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term "about" which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect” “to, at least, provide,” “to, at least, transmit,” and so on.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and non-volatile memory). These devices may also have at least one input device (e.g., a keyboard, a mouse, a touchscreen, other input elements or any operable combination thereof) and at least one output device (e.g., a display screen, a printer, a wireless radio, other output elements or any operable combination thereof) depending on the type of device.

It should also be noted that there may be some elements that are used to implement at least part of the embodiments described herein that may be implemented via software that is written in a high-level procedural language such as object-oriented programming. The program code may be written in C, C⁺⁺ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Accordingly, any device described herein that executes software instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

The various embodiments described herein generally relate to apparatuses and methods for composting food waste, as well as paper products, cardboard products, and/or some plastics. Composting is the natural process of recycling organic matter, such as garden waste, yard waste and food scraps, into compost that can be used to enrich soil and plants. All organic discards decompose eventually; however, composting can be used to speed up the process by providing an ideal environment for composting to occur, for example by including naturally occurring or artificially inoculated microbial species.

On the other hand, users typically have to collect food scraps for longer periods of time before inputting the larger volume of scraps into the composter to produce a larger batch of compost. For example, a sufficient amount of waste may be collected to fulfill a composting criteria such as the critical mass that is preferred under cold/hot composting conditions for various types of microbial species. This is known as batch composting. However, batch composting requires the users to collect food scraps prior to placing a larger batch of food scraps into the composter. This may produce odors and other allergens such as mold and dust which can cause discomfort in the home or outdoor spaces. However, in some cases, mold may be used a typical fermentation activator of scraps in cold composting methods such as Bukashi composting, for example.

It is beneficial to have a composter in which users may continuously deposit a small amount of food scraps and yet obtain a large batch of compost. The continuous-to-batch process combines the freedom to add waste at any time while producing a controlled quality of batched output. Food waste from meal preparation, meal leftovers and snack leftovers can be added to the device as soon as they are generated, yet they can be accumulated in the device to still able to generate a useable batch of output compost.

The inventors have realized that in batch composting some batches of waste may need treatment prior to composting such as chopping and/or de-watering while other batches of waste may be ready for immediate composting without needing any pretreatment. Accordingly, the inventors have devised various embodiments of composting apparatuses which have multiple pathways for organic material to be inputted, processed and produced into compost. The embodiments described herein can be used to implement continuous to batch processing by using a multiple compost chamber system, such as a dual compost chamber, for example.

In one aspect, in accordance with the teachings herein, a dual lid system is provided herein for a composting apparatus which enhances the flexibility, efficiency, and usability of the composting device. The dual lid system selectively allows access to different pathways (e.g., compartments, chamber, containers or units of the composting apparatus) which allows waste to be selectively processed through these different pathways. The decision of which pathway to allow access of the waste to may be based on different conditions such as one or more properties of the waste. Accordingly, the dual lid system ensures that the composting process is as efficient and effective as possible. The dual lid system therefore offers users a highly optimized waste management solution. The dual lid system may include two lids, actuators for the lids, sealing element for the lids, one or more actuators for the lids and a control unit.

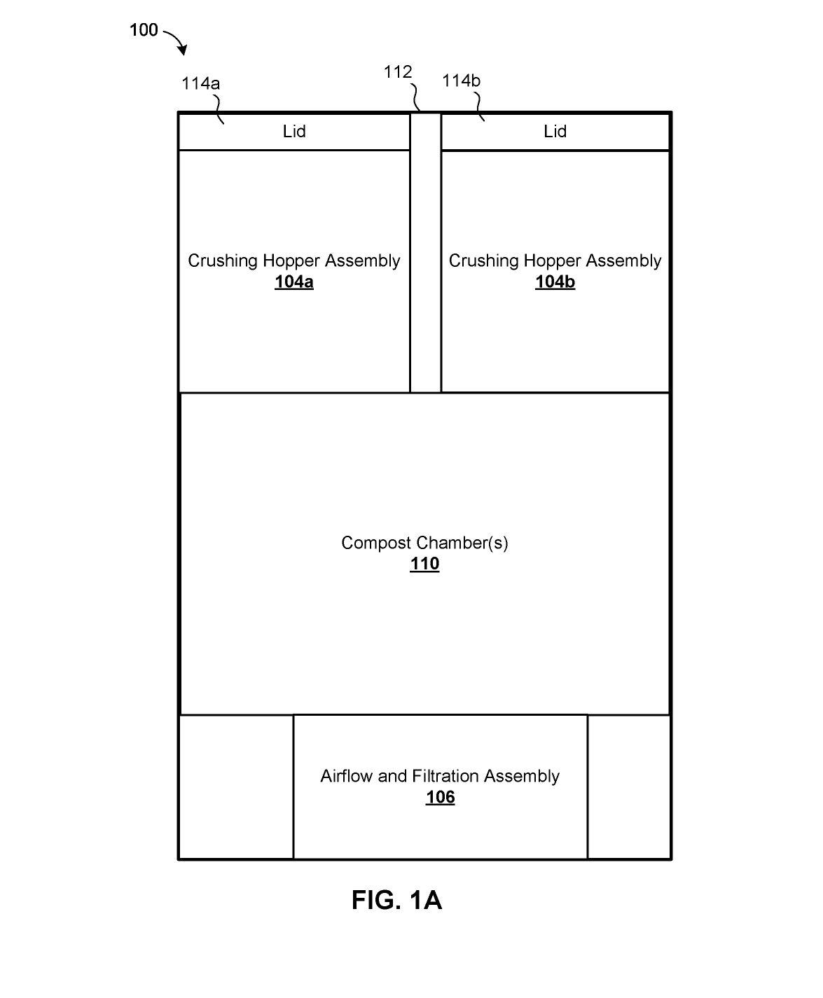

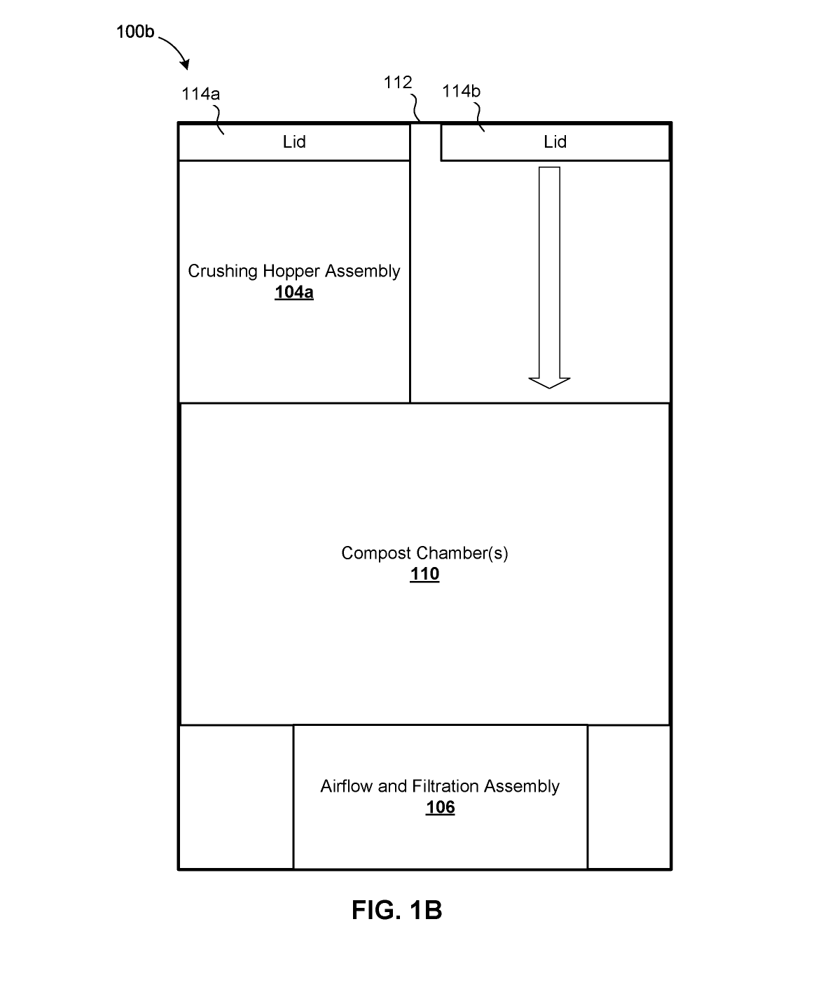

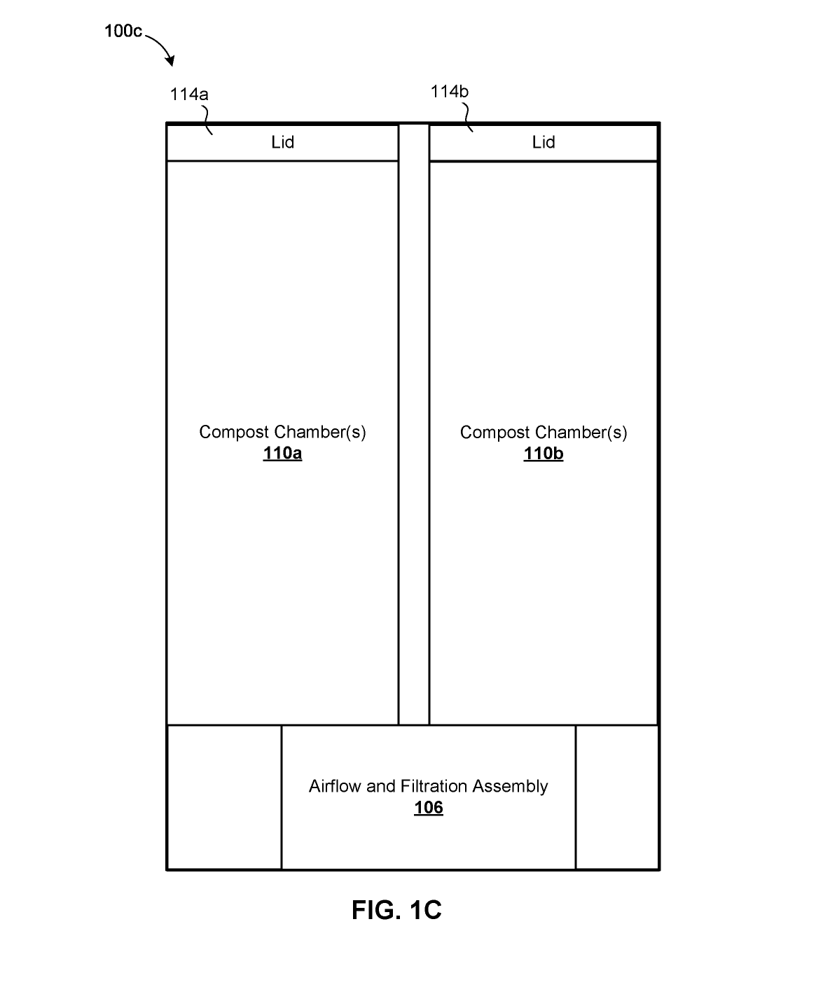

Referring now to FIG. 1A, shown therein is a block diagram of a composter assembly according to an example embodiment. The composter assembly may also be referred to as a composting apparatus. The composting apparatus 100 may include: a main device body 112 (e.g., housing), at least one compost chamber 110 located within the main device body 112, a first crushing hopper assembly 104a connected the at least one compost chamber, and a second crushing hopper assembly 104b connected to the at least one compost chamber. Each of the crushing hopper assemblies 104a, 104b may be closed, or accessible by a plurality of lids 114a and 114b.In at least one embodiment, the lids 114a, 114b may be motorized (e.g., physically connected to an actuator) for selectively opening and closing the lids 114a and 114b. The composting apparatus 100 may further include an airflow and filtration assembly 106, which can be fluidly coupled to the compost chambers 110.

In at least one embodiment, the plurality of lids 114a, 114b can be made from durable, heat-resistant plastic or metal. The lids 114a, 114b can also feature an airtight seal to prevent odor leakage via a sealing element or sealing mechanism. In at least one embodiment the lids 114a, 114b or the sealing element may be coated with an antibacterial or odor killing components to reduce odors in addition to prevent odor leakage. In at least one embodiment, the lid and sealing element can be implemented to minimize/reduce moisture escape from the composting apparatus. In at least one embodiment, the lid can be implemented to as a condenser to return water droplets back into the compost chamber and/or crushing assembly depending on the implementation. In such embodiments, the lids 114a, 114b can include airtight gaskets to ensure that no odors escape during the waste insertion process. Alternatively, in at least one embodiment, the airtight seal may be provided by an element, such as an airtight gasket or other seal that is located on the portion of the main body 112 which receives the lids 114a and 114b when they are closed. Furthermore, the crushed waste and directly inserted waste can be both subject to the airflow and filtration system 106 that neutralizes odors before they exit the composter.

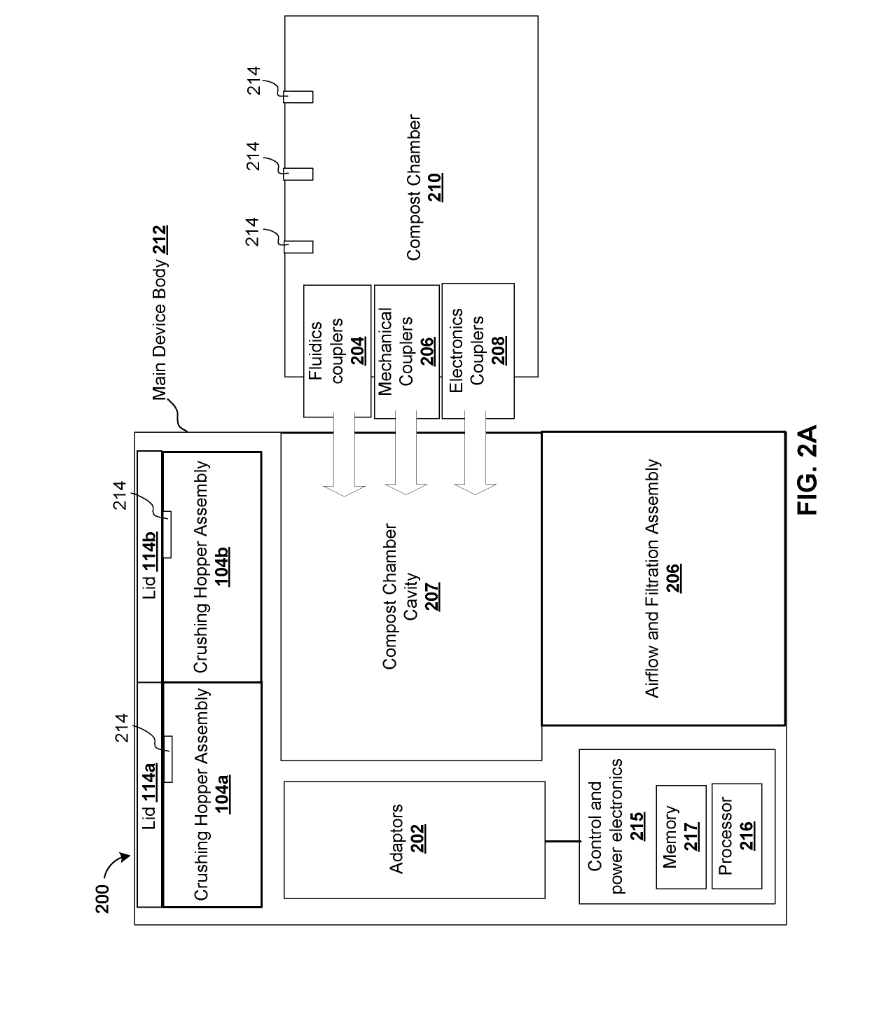

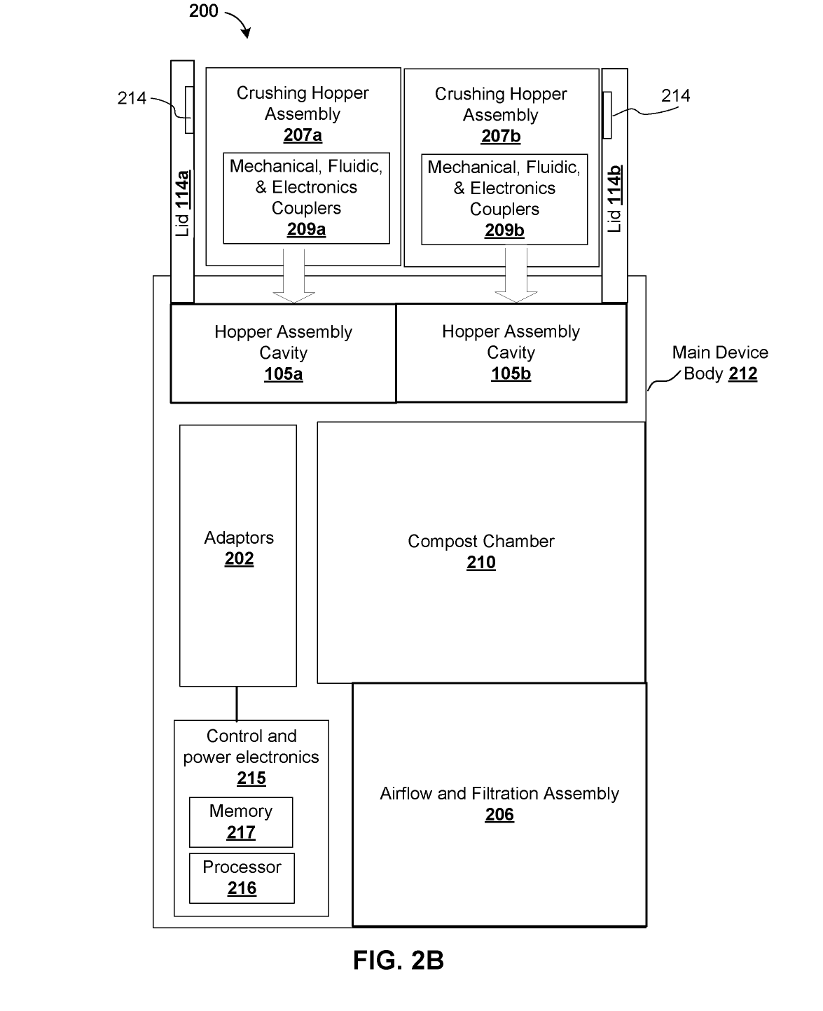

In at least one embodiment, the lids 114a, 114b can be attached to the body of the composter 1000 via a hinge mechanism that allows for easy opening and closing. In at least one embodiment, the lids 114a, 114b can be motorized and actuated under the control provided by a processor (an example is shown in FIG. 2AA). The processor may be located in a control unit. The control unit may be provided as part of the dual lid system or otherwise be communicatively coupled to the dual lid system. In at least one embodiment, the lids 114a, 114b can be equipped with a secure latch to ensure that the lids 114a, 114b remain closed during the crushing process. The locking system or latch can also be motorized to automatically open and close based on instructions from the processor. In one embodiment, at least one sensor can be embedded in the lids 114a, 114b or a portion of the main body 112 to detect if one of the crushing assemblies 104a, 104b is obstructed, preventing overloading or jamming. The crushing blades of the crushing hopper assemblies 104a, 104b can be configured to stop immediately if one of the lids 114a, 114b that is opened and provides access to the jammed crushing hopper assembly 104a, 104b, during operation. For example, lid interlocks can be provided to prevent both lids 114a, 114b from opening simultaneously, ensuring controlled airflow and preventing odor leaks. Crushing assembly interlocks can be provided to disable the crushing blades when the first lid is opened, preventing injury to the user or damage to the composting apparatus.

FIG. 1B shows another example embodiment of a composter assembly 100b. In this embodiment, waste inserted through the first lid 114a, can be directed into the crushing assembly 104a. Any of the crushing assemblies described herein include rotary blades, grinders, or crushers powered by an electric motor. This crushing assembly is designed to reduce the size of the waste material for faster composting. Furthermore, waste inserted through the second lid 114b bypasses the crushing assembly 104a and is routed directly to the compost chamber 110. This is useful for waste materials that do not need mechanical processing, such as soft or pre-chopped food scraps.

In one embodiment, the composter assembly 100b can be configured to allow users to choose which lid to use based on the type of waste they are disposing of. In this embodiment, users can directly choose which lid to open based on their judgment of the waste input. The user interface allows easy selection of the desired lid using a control panel or a mobile app connected to the device via Bluetooth or Wi-Fi. The user can select the first lid 114a for waste that requires crushing via the crushing hopper assembly 104a or the second lid 114b for waste that can be directly composted.

In embodiment 100b, both lids ultimately lead to the composting chamber, but via different routes. Waste that enters through the first lid 114a can be first processed by the crushing assembly 104a and then transferred to the composting chamber(s) 110 (in various embodiments there may be two or more composting chambers for composting a greater amount of waste material and the crushing assembly 104a may be coupled to each of these composting chambers. This route that flows through the crushing assembly 104a and the composting chamber(s) 110 is optimized for tough or bulky waste materials that require size reduction for more efficient composting. Waste entering through the second lid 114b skips the crushing assembly 104a and is deposited directly into the composting chamber 110, saving energy and processing time for softer waste materials.

By allowing different waste types to follow different processing pathways, the system ensures that each type of waste is processed in the most effective way, leading to faster and more efficient composting. By processing waste in an optimal manner, the system reduces odor, improves compost quality, and minimizes the time required for composting. Furthermore, the crushing assembly is only activated when necessary, which reduces the overall energy consumption of the device.

FIG. 1C shows yet another example embodiment of a composter assembly 100c, in which the crushing hopper assemblies 104a, 104b shown in FIG. 1A are removed. In this embodiment, the removal of the crushing chamber can reduce the overall complexity of the system, and thus increasing reliability and viability of the system. In this embodiment, the composting apparatus 100c may include: a main device body 112 (e.g., housing), and at least one compost chamber 110 located within the main device body 112. Each of the least one compost chamber 110a, 110b may be accessible by lid 114a and 114b.The composting apparatus 100c may further include an airflow and filtration assembly 106, which can be fluidly coupled to the compost chambers 110.

In at least one embodiment, multiple (more than two) lids can be implemented to allow input waste to enter into multiple chambers with specific conditions to produce compost or other outputs with value. In an embodiment, multiple chambers can be provided as an extension of dual chamber design. The multiple lid design allows specific lids to open depending on the input conditions assessed, allowing input into chambers with varying conditions including those mentioned in the embodiments. In this way, high quality source separated organics (SSO), particularly inside community organics collection facilities to enforce proper waste separation. Thus, more than two chambers can be provided in the composting assembly, each being coupled to a lid. This allows further segregation of the input waste if needed.

Turning now to FIGS. 2A and 2B, which shows a block diagram of a composter apparatus 200, according to an example embodiment. The composter assembly 200 can further include functional components that assist in the functioning of the composter. The functional components may include, but are not limited to: mechanical components, electrical and electronic components, fluidic components or any operable combination thereof. The mechanical components include, but are not limited to, mixing components, motor shafts, transfer components, trap doors, windows, spring-loaded contraptions or any operable combination thereof. Electrical and electronic components include, and are not limited to, electrical motors, heaters, fans, pumps, temperature sensors, moisture sensors, oxygen sensors, load sensors, position sensors, level sensors, image sensors, LEDs or any operable combination thereof. Fluidic components include, but are not limited to, nozzles, tubing, fittings, sprayers, atomizers, filters, valves, aerators, reservoirs or any operable combination thereof.

In the example embodiment shown in FIG. 2A, the compost chamber 210 is removeable. In at least one alternative embodiment, the compost chamber 210 may be fixed. The removable compost chamber 210 can be removed from the main device body 212, which might occur for cleaning and/or maintenance of the compost chamber 210. However, various couplers and adaptors can be implemented such that the couplers can removably engage the adaptors in a controlled and predictable manner so that once the compost chamber 210 can be reinserted into a compost chamber cavity 207 without an effect on functionality. In other words, after reinserting the compost chamber 210 into the main device body 212, the couplers can engage the adaptors so that the functional components residing inside the compost chamber 210 remain functional.

In the example embodiment shown in FIG. 2B, the crushing hopper assemblies 207a, 207b are removeable. In at least one alternative embodiment, the crushing hopper assembly 207a, 207b may be fixed. The removable crushing hopper assembly 207a, 207b can be removed from the main device body 212, which might occur for cleaning and/or maintenance of the crushing hopper assembly 207a, 207b, or for direct access to the compost chamber 210. In another example embodiment, the crushing hopper assembly 207a, 207b can be removed if the organic waste entering the compost chamber 210 does not need to be crushed or milled by the crushing hopper assembly. Various couplers 209a, 208b can be implemented such that the couplers 209a, 209b can removably engage the adaptors (that are installed in the main device body 212) in a controlled and predictable manner so that the crushing hopper assembly 207a or 207b can be reinserted into the main device body 212 with ease. In other words, after reinserting the crushing hopper assembly 207a, 207b into the main device body 212, the couplers can engage the adaptors so that the functional components residing inside the crushing hopper assembly remain functional, and the crushing hopper assembly becomes connected to the compost chamber 210.

Fluidic couplers can be coupled to fluidic adapters. For example, referring to FIG. 2A, the fluidic couplers 204 and fluidic adapters can be used to transfer fluids in and out of the compost chamber 210 while referring to FIG. 2B the fluidic couplers of couplers 207a, 207b can be used to transfer fluids to the compost chamber 210. Examples of fluids that may be transferred into the compost chamber 210 include, but are not limited to, water, oxygenated water, alcohol, oxygen gas, nitrogen gas, air, compressed air, ethylene, carbon dioxide, any other fluid required during the composting process, or any operable combination thereof that is operable. Examples of fluids that may be transferred out of the compost chamber 110 include, but are not limited to, clean water, oxygenated water, grey water (also referred to as “juice”), alcohol, oxygen gas, nitrogen gas, air, compressed air, ethylene, carbon dioxide, any other fluid emitted during the composting process, or any operable combination thereof. The term juice may be used If the dewatering process happens through use of mechanical means where particulates float inside the fluid media, since the result is a “juice-like” liquid. This juice is quite common at the bottom of the composting buckets of composting systems and is concentrated with high nutrient contents. This juice may also be sometimes referred to as leachate or compost tea.

Mechanical couplers can be coupled to corresponding mechanical adapters. For example, referring to FIG. 2A, the mechanical coupler 206 and corresponding mechanical adapter can be used to transfer power from a motor to drive a mechanism, while referring to FIG. 2B, the mechanical couplers of couplers 207a, 207b can be used to power from a motor to drive a mechanism in the crusher hopper assemblies 207a, 207b. The shaft may be connected to any driven mechanism such as, but not limited to, one of an: impeller, pedal, auger, piston, blade, juicer, or any other crushing, grinding, mixing, transfer, or pulverizing mechanism depending on whether the driven mechanism is in the compost chamber 210 or the crushing assemblies 207a, 207b. A motor is typically located outside the chamber / crushing assemblies in which moveable elements/driven mechanisms are housed that are driven by the motor. Such chambers may include the pre-treatment (e.g., crushing assembly), a storage chamber (not shown), and/or the compost chamber. In at least one embodiment, two or motors may be used for driving corresponding shafts. In at least one embodiment, one motor may be used along with belts and/or gear assemblies / gear boxes to device multiple shafts.

The driven mechanism may be removably connected to the shaft so that the driven mechanism may be removed for cleaning and/or maintenance or also interchanged for another type of drive device. For instance, the crushing hopper assembly 104a, 104b, 207a, 207b may comprise a crusher for grinding hard foods such as bones or fruit pits. In another instance, the compost chamber 110, 110a, 110b, 210 may comprise an impeller for further grinding or crushing of the organic waste. For example, the user can change different impeller attachments depending on the type of food. Alternatively, different attachments coupled to the shaft can be used depending on the function needed. For instance, a brush attachment may be coupled to the shaft to clean the inside of the chamber, a blunt impact blade may be removably coupled to a shaft to provide a crushing function, a pedal blade may be removably coupled to a shaft to sweep up material and carry them upwards or move them in another direction, an aerated blade may be removably coupled to a shaft to provide further aeration through injected air streams, an injection blade may be removably coupled to a shaft to inject water as it rotates, a heat-able blade may be removably coupled to a shaft to provide conductive heating, or any operable combination thereof.

Electronic couplers may be used for transmitting signals between a processor 216 and the various chambers and assemblies (depending on the embodiment) such as the compost chamber 110, 110a, 110b, 210 and the crushing hopper assemblies 104a, 104b, 207a, 207b. In one embodiment, sensors 214 can be provided throughout the main body 112, or within compost chambers 110, 110a, 110b, 210 to collect sensor data about the conditions of the compost chamber 110110a, 110b, 210. In one embodiment, the sensors can exist generally in the main body, inside the lids, or inside the chambers. In another embodiment, sensors 214 can be provided on the lid 114a, 114b to collect sensor data about the conditions of the lid (i.e. open, closed, etc.) and/or the waste material that is deposited once the lid 114a, 114b is opened. The sensor data can be sent for storage to a memory 217 and/or to the processor 216 for processing. The memory and the processor 216 may be located in a control unit. The control unit may be included as part of the dual lid system or otherwise communicatively coupled to the dual lid system. The sensor data may be sent as electrical signals that may be transmitted via the electronic couplers 208 and the electronic adaptor 202. In another embodiment, the signals collected from sensors 214 may be sent directly to the processor 216 for processing. This may occur where the processor 216 has an analog input I/O pin to read the voltage measured by a given sensor, and then uses an Analog to Digital Converter (ADC) to convert the analog reading into a digital reading, and then process the digital reading using an algorithm to convert the digital reading into a corresponding physical reading. The physical reading may then be stored inside memory 217. The one or more sensors 214 may include, but are not limited to, one or more temperature sensors, one or more pressure sensors, one or more moisture sensors, one or more relative humidity sensors, one or more gas sensors, one or more level sensors, one or more hall effect sensors, one or more load cells (i.e., sensors for weight measurement), one or more image sensors or any operable combination thereof. In an alternative embodiment, other weight sensors may be used rather than load cells. In another alternative embodiment, other proximity sensors may be used other than hall effect sensors. In at least one embodiment, at least one level sensor may be used. Examples of other proximity and level sensors that may be used include, but are not limited to, inductive, capacitive, ultrasonic, and/or infrared sensors. Examples of other weight sensors that may be used include, but are not limited to, pressure/strain sensors.

In at least one embodiment a waste detection algorithm for dynamically controlling the opening and closing of the lids of the compost chambers is also provided. The waste detection algorithm can provide an automated solution for waste management, improving the user experience and reducing manual intervention. The waste detection algorithm may be stored in the memory 217 and executed by the processor 216 which will configure the processor 216 to operate in a new unique way.

The processor 216 is operatively/communicatively coupled to a plurality of lids as well as one or more sensors that may be located in the lids and/or within the main body 112, 212. The one or more sensors are configured to collect data. The memory 217 is communicatively coupled to the processor 216 and is configured to store sensor data, optionally historical information, and instructions for executing the algorithm. The processor 216 is programmed to receive and process the sensor data from the sensors, determine the state of the lids (e.g., open or closed), detect compost chamber fill levels, analyze characteristics of waste entering a chamber (e.g., compost chamber, and crushing hopper assembly) that is accessible by one of the lids. In at least one embodiment, the processor 216 may also be configured to analyze one or more characteristics of the existing compost in the compost chamber(s). The sensors may be sensors an external sensor that is external to the composting apparatus, such as a sensor provided by a mobile device, for example, or the sensor may be connected with the composting apparatus or be an embedded sensor (e.g. image sensor) in the composting apparatus.

Depending on the location of the sensors, the sensors can be used to collect various data such as the fill levels of the chamber, the state of a lid, waste-specific characteristics such as size, type of input waste, moisture content, the weight of the input waste, mass/amount of input waste, the hardness of the input waste, one or more characteristics of the existing compost in the compost chambers or any other predefined parameters. Typical waste-specific characteristics can include: bulk column, bulk weight, images, input waste class (e.g. organics, inorganic, metal, glass, plastic, etc.), input organics class (e.g. banana, orange, chicken), input odor, etc. In one embodiment, these characteristics can be directly measured by the sensors and then be provided to the processor, or, provided to the processor by a database or memory. The processor can then infer input nutrient contents (e.g. moisture content, carbon content, NPK values, sugar/lipid/protein/carbohydrate/fiber ratios, etc.). It should be noted that the terms “input waste” and “incoming waste” have the same meaning and may be used interchangeably.

In at least one embodiment, these sensors may also be used as a safety mechanism by detecting a damaging component in the input waste, such as plastic, that should be removed to avoid damaging the composter in which case the user can be prompted to remove the damaging component of the input waste.

The processor 216 can utilize the sensor data to evaluate the conditions in a given chamber (e.g., a crushing hopper assembly and/or a compost chamber), and determine which lid to open for each piece of new incoming waste. For instance, for embodiments having two compost chambers such as embodiment 100c, when the sensor data indicates that the fill level of the first compost chamber is about to exceed a predetermined fill-level threshold, the processor 216 can generate a control signal to open the second lid, and close the first lid, thereby facilitating waste entering the second compost chamber to alleviate overfilling of the first compost chamber. Conversely, if the waste in a chamber is below the fill-level threshold, the processor 216 can decide whether to open or close the corresponding lid to maintain optimal fill levels.

The system can also execute more granular decisions based on waste-specific characteristics. For example, if an incoming piece of waste meets certain predefined criteria, the processor 216 can be configured to determine which lid to open and generates a corresponding control signal. In at least one embodiment, the waste detection algorithm, which may be AI-based, can be used that automatically decides which lid to open based on sensor data. The sensors can include: optical sensors that obtain images for which the processor 216 can use image recognition to determine the size, shape, and color of the incoming waste; weight sensors to detect the mass of the incoming waste, which can also help identify its type; moisture sensors to assess the wetness of the incoming waste, and/or gas sensors to assess the chemical composition or one or more chemical characteristics (e.g., pH) of the incoming waste. The processor 216 can be configured to analyze the sensor data to determine if the waste is suitable for direct composting or requires crushing. The processor 216, by executing the algorithm, can process this data and determine which lid to open. For example, for hard, dense waste (e.g., potato peels, citrus rinds) the processor can trigger the first lid to open, sending the waste to the crushing assembly. On the other hand, soft, easily decomposable waste (e.g., leafy greens, coffee grounds) or foods that have pungent odors when crushed/blended, like garlic for example, will cause the second lid to open, bypassing the crushing assembly and directly entering the compost chamber. This functionality allows selective routing of waste based on operational requirements. The memory device 217 can further store historical data related to chamber fill levels and lid activity, allowing the processor 216 to optimize its decision-making algorithm over time by identifying patterns or trends.

In at least one embodiment, for example, one of the chambers could accept organics polluted by plastic bits, and by introducing plastic digesting medium combined with various physical conditions such as temperature, RH, airflow, etc., would create conditions suitable this type of input. Other example input types can be source separated organics (SSO) with high fibre, high lipid (oily), or high mold initial conditions, which might require specific conditions inside the compost chamber. The lid system can be used to prevent the wrong type of input to enter the chamber with wrong conditions.

The algorithm can further employ weighted factors to prioritize decisions. For example, under normal conditions, the processor 216 executing the algorithm may be configured to prioritize reducing overfilling, whereas in other scenarios such as a high amount of hard food, it may prioritize opening all lids with the crushing hopper to facilitate crushing. The processor 216 can be configured to implement a hierarchical decision-making structure that evaluates multiple criteria, such as chamber fill levels, lid status, incoming waste characteristics and/or characteristics of the compost in one or more compost chambers, depending on the composter assembly implementation in real-time to determine the optimal lid operation.

In an example embodiment, the system can also include a feedback loop wherein the processor 216 continuously updates its analysis based on the most recent sensor inputs. For instance, if the processor 216 is configured to determine that opening a second lid has effectively reduced overfilling in the first chamber, the processor 216 can send a signal to maintain the second lid in an open state or transition to a closing state as necessary. Similarly, if the processor 216 is configured to detect a steady influx of waste meeting specific criteria (such as high moisture content, or high hardness, chemical/food composition that may optimize the compost output or processing of the current compost in the compost chamber, etc.), it can adapt its decision-making process to dynamically manage inflow through the plurality of lids. In another embodiment, if the processor 216 is configured to determine that the first chamber is undergoing composting, the processor 216 may be configured to send control signals maintain open the second lid to fill up only the second chamber with incoming waste, while keeping the first lid closed so that the first chamber remains unavailable to the incoming waste.

In at least one embodiment, at least one of the sensors can be an image sensor or camera. The image sensor or camera can be inside the chamber, on the lid, or outside of the composting assembly. The image sensor can acquire image data which is then sent to the processor 216 which can be configured to run an image processing algorithm on the image data to determine the type of incoming waste.

In at least one embodiment, the user can take photos of the input waste with a mobile phone, or while the waste is in common cooking or meal leftover scenarios, such as on a counter-top, on a table, inside a bucket, on a plate, on a cutting board, inside the fridge, etc. The photos taken by the user mobile device can be used as an input to the processor to run the algorithm. In at least one embodiment, the lid can also open depending on the time of the week to detect which chamber is available for receiving inputs, as one of the chambers would be batch processing and cannot be interrupted. In one embodiment, an app can be provided on the mobile device connected with the composter. The app can use the device camera to take a photo of the waste right before it is about to be thrown into the composter, and the mobile device can process the photo to determine which lid should open. In an alternative embodiment, the mobile device can send the image to a cloud-based processor or the processor 216 within the composter to process the photo.

In another embodiment, the processor 216 may be configured to execute an image processing algorithm to identify the type of food depicted in an image. The processor can receive a digital image from the image sensor or camera. The digital image can be stored in the memory 217 and analyzed by the processor 216 by using a sequence of computational steps. Initially, the image data is pre-processed to enhance features that may be used for food identification. This may involve resizing and/or rescaling the image to a standard resolution, normalizing color values, and/or applying filters to reduce noise in the pre-processed image data. The pre-processing stage ensures consistency in the pre-processed image data, allowing the subsequent stages to operate more effectively.

Once pre-processed, the pre-processed image data can be processed by the processor 216 to undergo feature extraction to identify specific attributes that are characteristic of various food or waste types. For example, the processor 216 may be configured to execute a series of algorithms, such as convolutional neural networks (CNNs), to detect and quantify features such as color distributions, textures, shapes, and patterns within the pre-processed image. These features are mapped to a feature space, where each point corresponds to a unique set of attributes. For instance, the rounded shape and bright red color of an object in the image may strongly correlate with the features of a tomato.

In at least one embodiment, the processor 216 can be configured to compare the extracted features against a pre-existing database of food profiles. The database, stored in memory 217 accessible to the processor 216, contains feature vectors associated with a wide variety of food items. Using a classification algorithm, such as a softmax classifier or support vector machine (SVM), the processor 216 can be configured to calculate the similarity between the extracted features and the database entries. The highest similarity score is used to determine the most likely type of food depicted in the image. In some embodiments, confidence levels or probabilities can be generated alongside the classification result to indicate the reliability of the identification.

In cases where ambiguity arises, the processor 216 can be configured to employ additional processing techniques to refine the identification. For example, contextual analysis of the surrounding environment within the image can provide supplementary information. If multiple objects are detected in the image, the processor 216 can be configured to analyze co-occurrence patterns based on known food combinations stored in the database. For instance, the presence of pasta alongside a red sauce may suggest the identification of a specific dish, such as spaghetti with marinara sauce, rather than a standalone tomato. In at least one embodiment, the processor 216 can also be configured to identify characteristics associated with the identified food image, such as moisture content, hardness or one or more chemical characteristics such as chemical composition, for example. For example, for avocado pits the processor 216 can be configured to assign a pre-determined hardness factor; as compared to a tomato which has low hardness but high moisture content.

Finally, the output of the food identification process can be used by the processor 216 to selectively actuate the appropriate lid to be open. Based on the characteristics identified, the processor 216 can be configured to actuate the appropriate lid combination. For example, for the avocado pits the processor 216 can be configured to send a control signal to open the lid corresponding to the crushing assembly. For the tomato, the processor 216 can be configured to send a control signal to open the lid corresponding to the bypass, and pass the waste directly to the chamber. In some embodiments, the processor may be configured to send a control signal to open the lid corresponding to a dewatering assembly for food with high moisture content, and run a dewatering cycle prior to transferring to the dewatered waste to the compost chamber.

As such, lid opening behavior can be determined via image processing inputs, chamber status, device status, time of the day, time of the week, or any other conditional triggers to cause any one or both of the lids to open.

In at least one embodiment, the processor 216 may be configured to execute machine learning techniques to continuously improve the accuracy of food identification. The processor 216 can be configured to update the database by learning from user feedback, new training datasets and/or data that is obtained during operation. If a user verifies or corrects the processor's identification of the appropriate lid to open, the system can update its internal models accordingly. This adaptive approach enables the algorithm to remain effective across a diverse range of food and waste items. In at least one embodiment, the dual lid system can be enhanced with more advanced sensors, such as infrared or spectral imaging, to provide even more precise waste identification. Additionally, the system may incorporate predictive algorithms that learn user habits and preferences over time, automatically optimizing the lid selection based on historical data.

In at least one embodiment, the user can receive feedback about the waste processing through an integrated mobile app, which provides real-time data on which lid was used, the status of the compost, and any necessary maintenance actions. Alternatively, in at least one embodiment, the composting apparatus can include a display screen to display information about the waste processing. This information can include any combination of composting status, temperature, humidity, fill level, and composting quality (e.g., based on food or waste inputs).

In these various embodiments described herein, the disclosed system and method provide an intelligent, adaptive solution for controlling compost chamber lids in environments where fill levels and waste characteristics can be dynamically managed. The integration of sensors, a processor, and a memory device within the compost chamber assembly ensures that the system can make real-time, data-driven decisions to optimize the flow of waste between interconnected chambers.

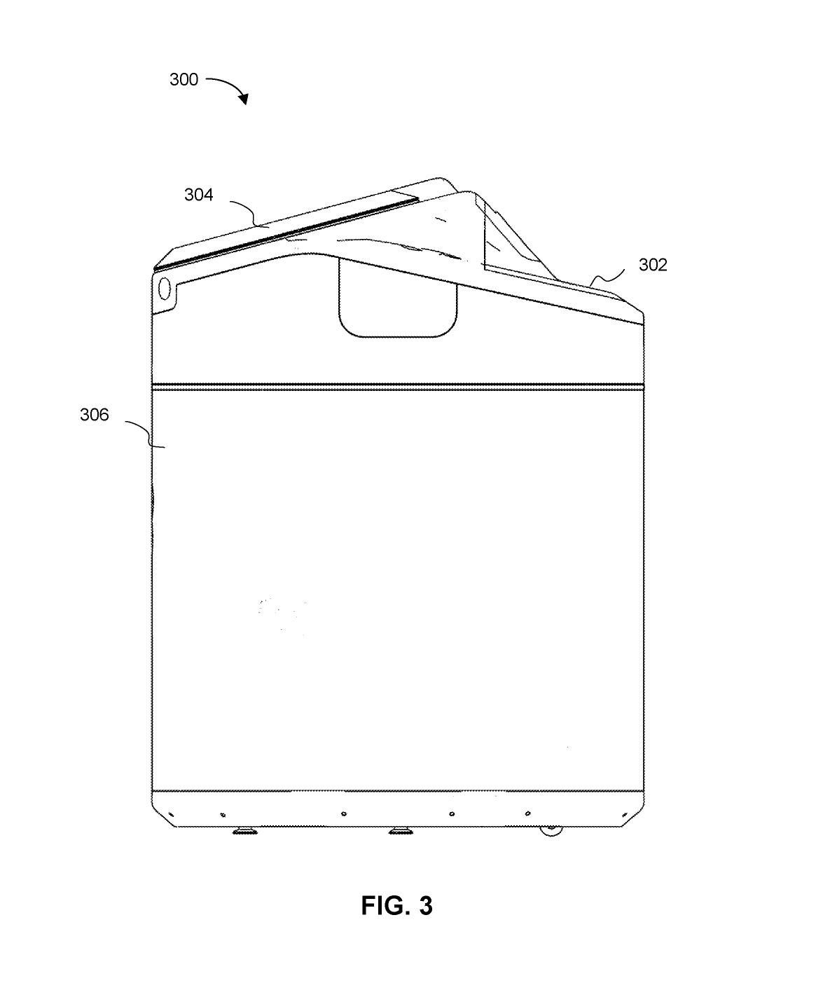

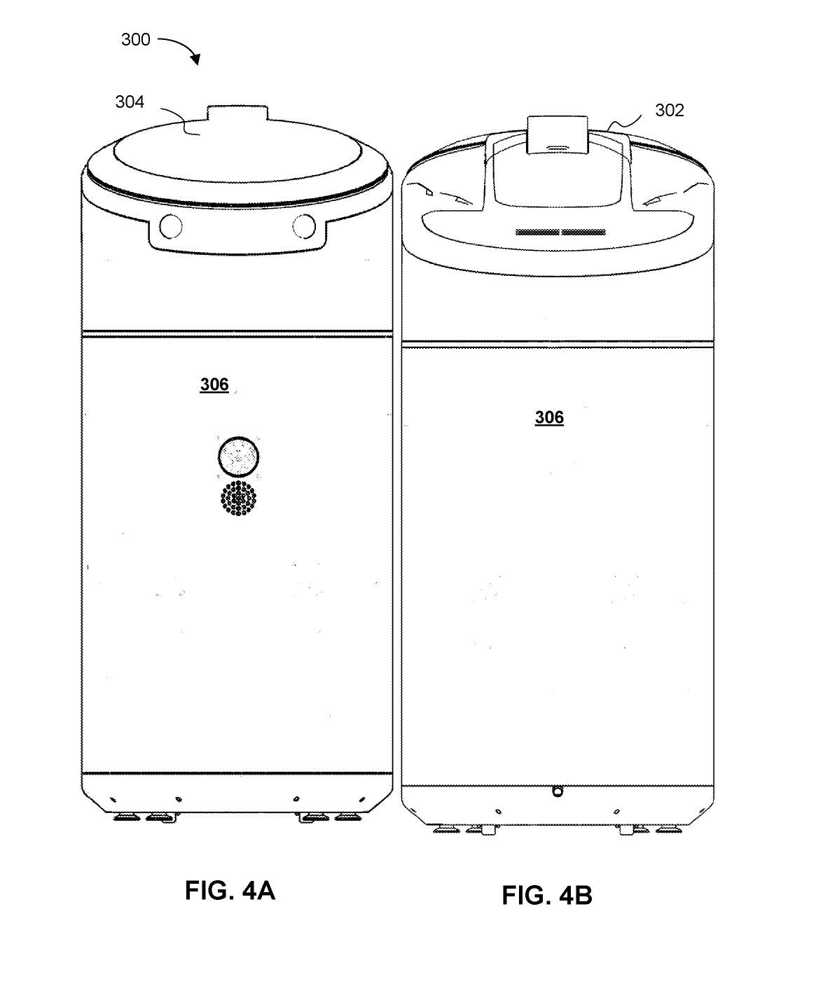

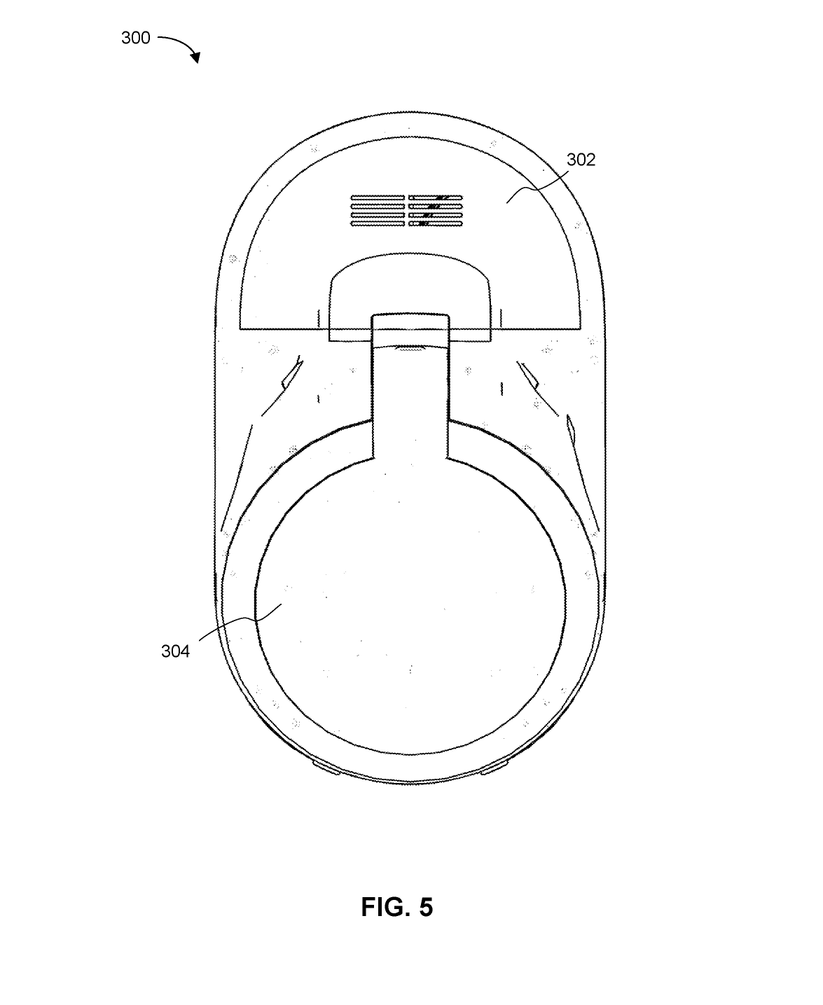

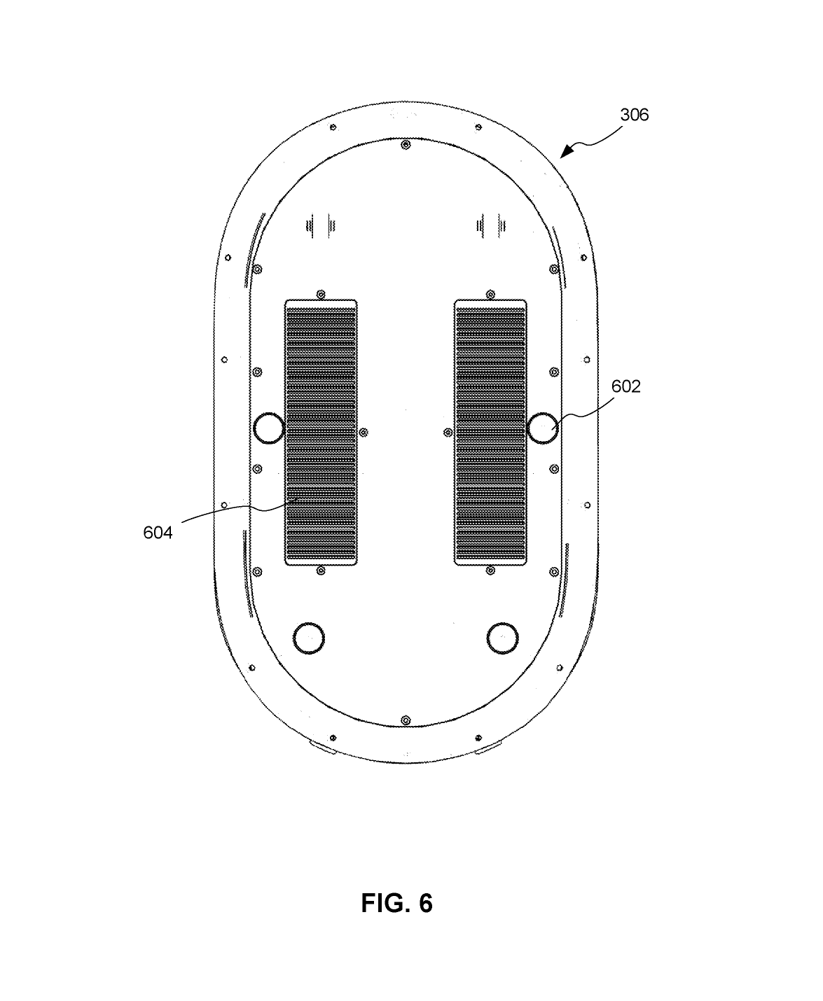

Referring now to FIG. 3, shown therein is a left-side view of a composting apparatus 300, according to an example embodiment. In this embodiment, the composting apparatus 300 includes: a main device body 306 (e.g., housing), a first lid 304 and a second lid 302 and dual compost chambers. The first and second lids 304, 302 can be located anywhere along the main device body 306, however for ease of use, the first and second lids 304, 302 can be located on the top of the main device body. FIG. 4A provides a front view of a composter assembly shown in FIG. 3. In this view, the first lid 304 is visible, and can be accessed by the front of the device 300. FIG. 4B provides a rear view of the composter assembly shown in FIG. 3. In this view, the second lid 302 is visible, and can be accessed by the rear of the device 300. FIG. 5 provides a top plan view of the composter assembly 300 shown in FIG. 3. In this view, both the first lid 304 and the second lid 302 are visible.

FIG. 6 provides a bottom plan view of the composter assembly 300 shown in FIG. 3. Vents 604 can be located on the main device body 306, such as at the base or bottom of the composter assembly 300. The vents 604 can be fluidly coupled to the airflow and filtration assembly 106 to allow the effluent air and gasses to escape the composting chamber. Pegs or feet 602 can be provided on the base of the composting assembly 300 to raise the bottom of the composting assembly 300 by a few centimeters to allow the gasses to vent easily through the bottom of the composter assembly 300. The feet may also provide friction and resistance to keep the composter assembly 300 from moving or shifting due to any high-frequency vibrations caused by the motors within.

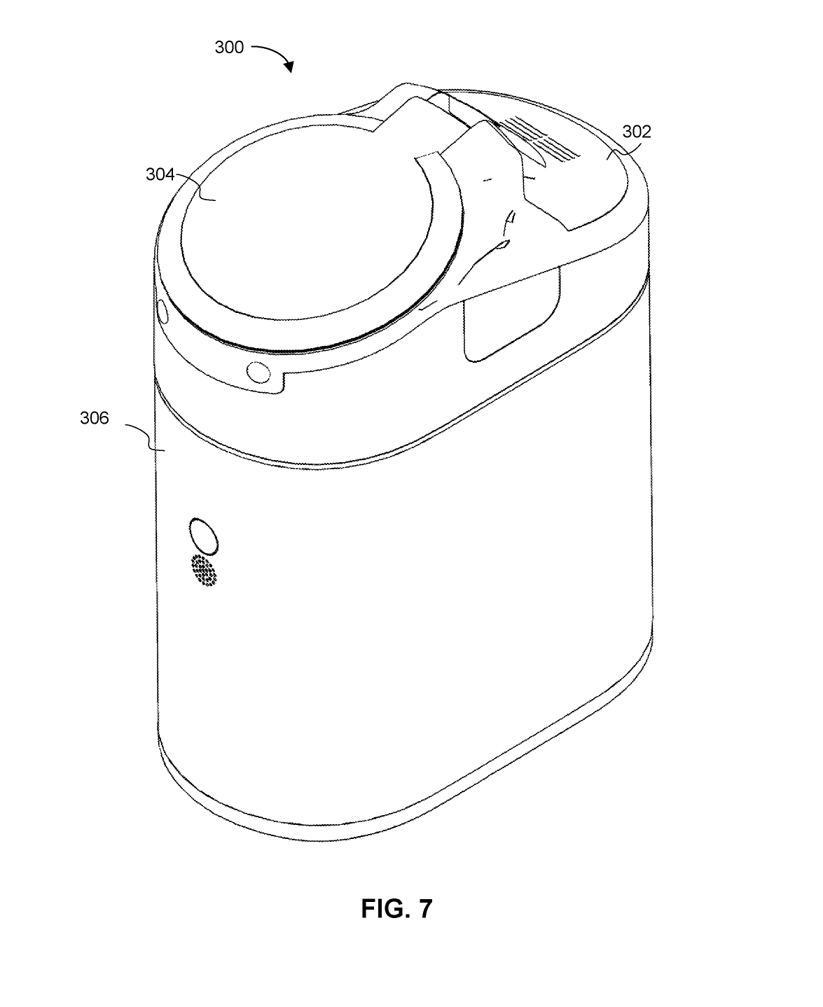

FIG. 7 provides a perspective view of the composter assembly 300 shown in FIG. 3, shown in a closed configuration. The composter assembly 300 can be in a closed configuration when it is running any of the treatment or composting cycles. In this embodiment, the first lid 304 and the second lid 302 are shut. The dual lid system enables users and/or automated algorithms to direct different types of waste into specific processing pathways, optimizing the composting process by selectively routing waste through a crushing assembly and then to a compost chamber or bypassing the crushing assembly entirely. The composter 300 is equipped with two distinct lids, each serving a specific function in the composting process. The first lid 304 routes the waste through a crushing assembly, which breaks down large or dense waste materials into smaller, more manageable pieces before they are transferred to the composting chamber. The first lid 304 is ideal for tough or fibrous materials like vegetable peels, fruit rinds, or bones that require size reduction for faster composting. The second lid 302 allows waste to bypass the crushing assembly and enter the composting chamber directly. The second lid 302 can be used for soft, easily decomposable waste such as coffee grounds, lettuce leaves, or other soft organics that do not require mechanical breakdown.

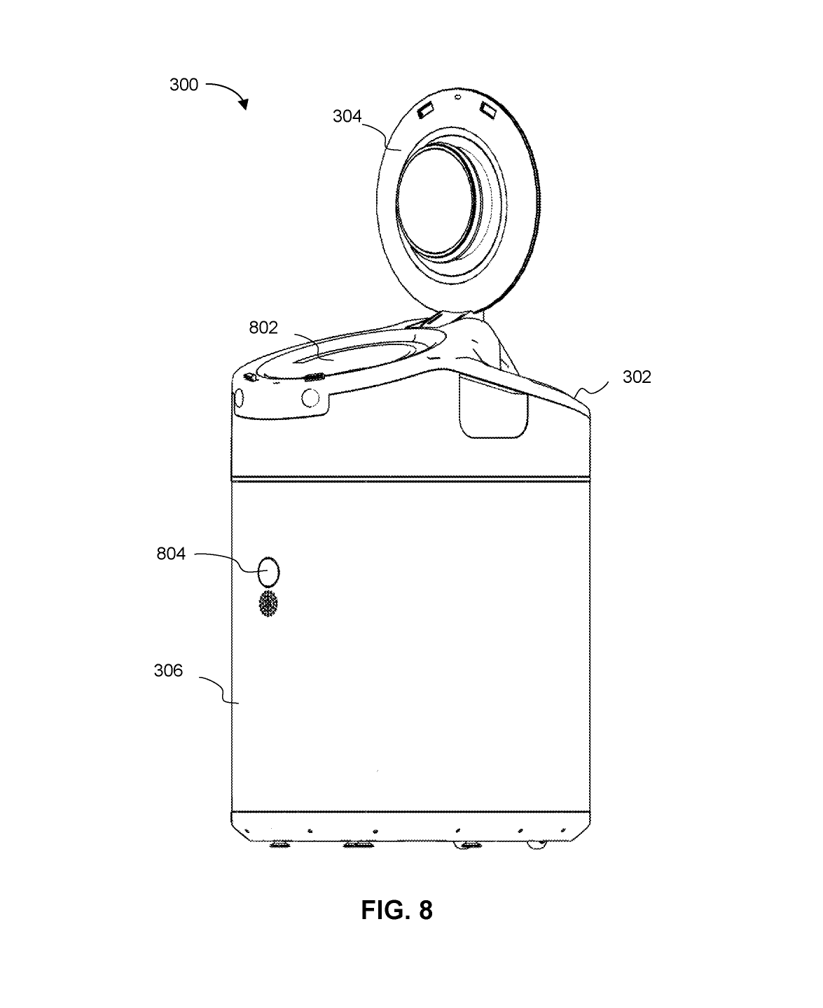

FIG. 8 provides a front perspective view of the composter assembly 3003, showing an open first lid. The first lid 304 can hinge open to allow a user to access a removeable crushing hopper assembly 802. Organic waste can be added to the hopper assembly 802, and the first lid 304 can be shut to allow the composter 300 to operate safely. Power button 804 can be pressed to turn the composter 300 on. Sensors in the lid 304 can relay to the processor that the lid is closed, and the composter 300 can be safely turned on.

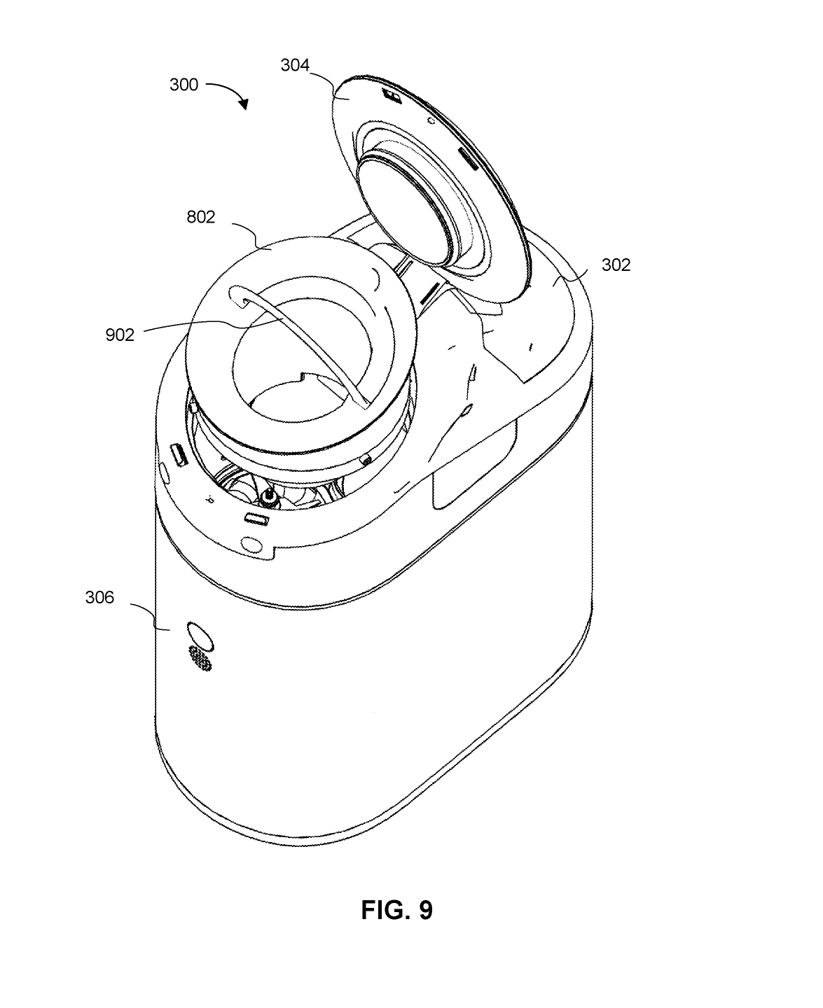

FIG. 9 provides a top-perspective view of the compost assembly 300. The user may open the lids 302 or 304 by using a switch that is connected to an actuator (both not shown) for moving the lids 302 or 304 between open and closed positions. As such, the hopper assembly 802 becomes exposed/accessible when the lid 304 is opened so that the user is able to insert food waste. The first lid 304 can hinge open to allow a user to access the crushing hopper assembly 802. The hopper assembly 802 can be removed, as shown in FIG. 9, using the handle 902.

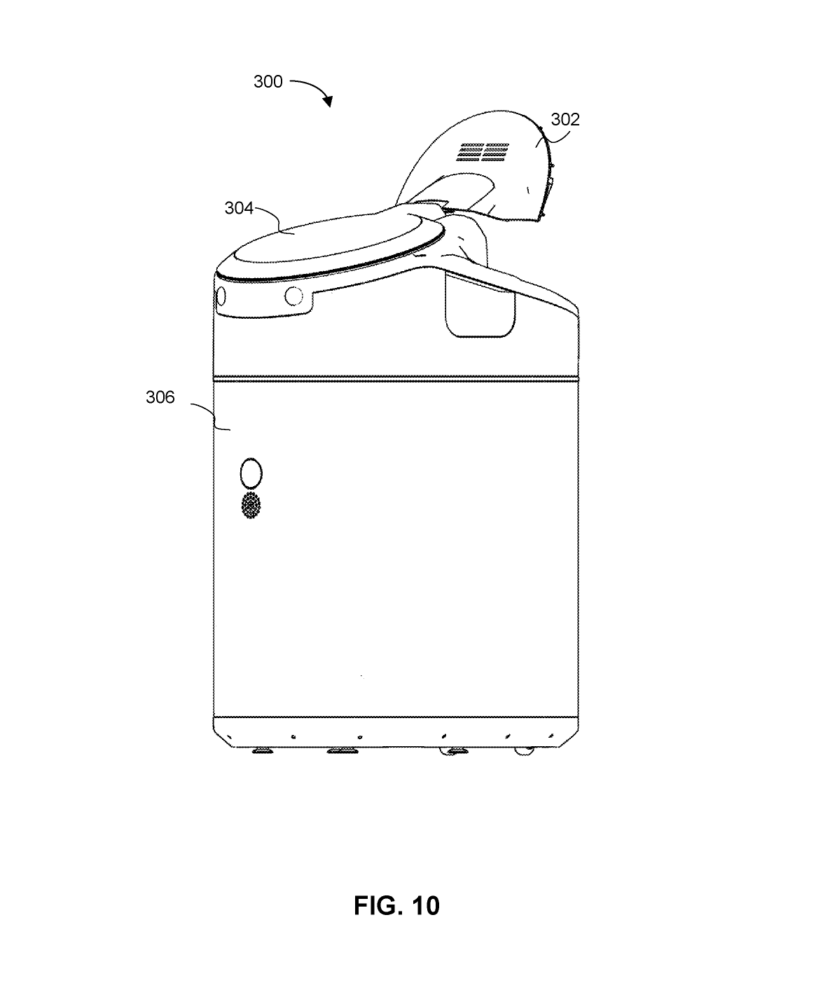

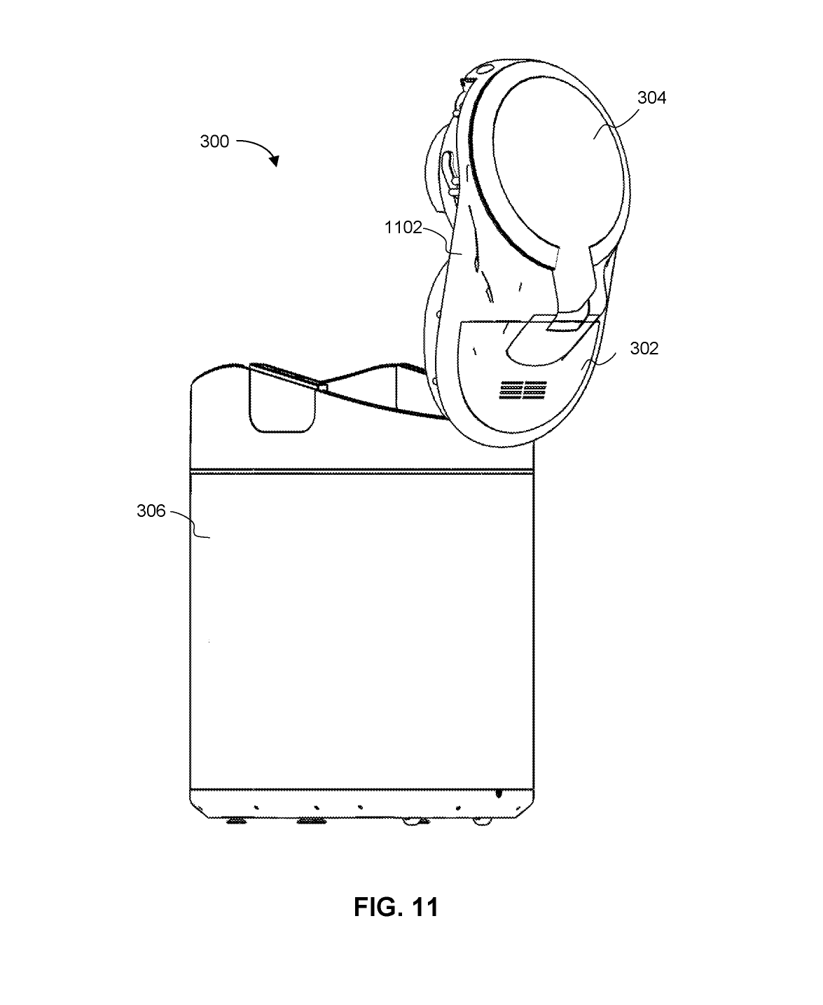

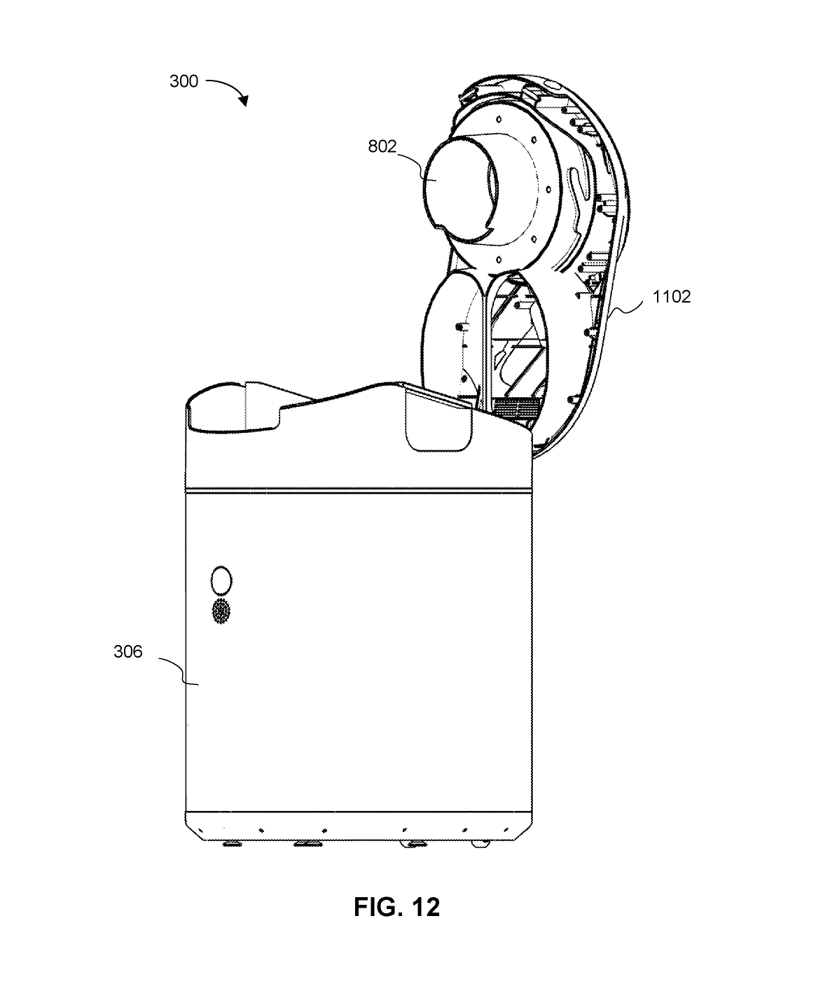

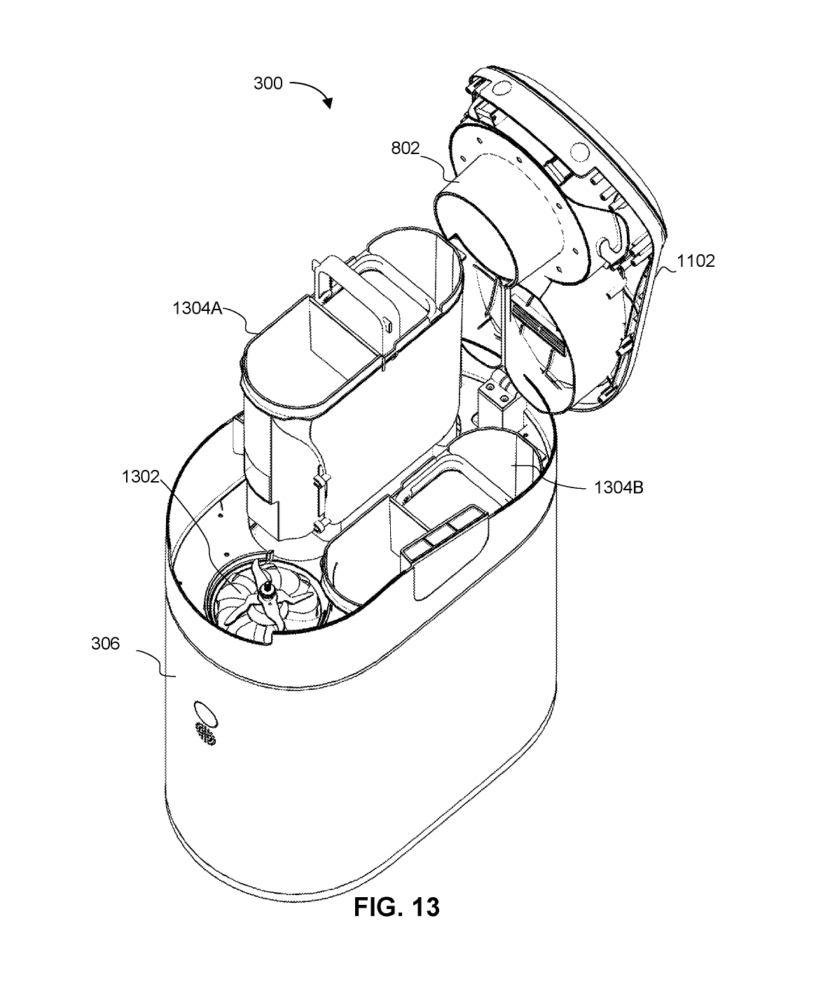

FIG. 10 is a rear perspective view of the composter assembly 300, showing an open configuration of the second lid. The composter assembly 300 further comprises a top hatch which hinges open to allow users to gain access to the dual compost chambers. FIG. 11 provides a front perspective view of the composter assembly 300 showing an open configuration of the top hatch. The top hatch comprises the lid assembly 1102 having the first lid 304 and the second lid 302. FIG. 12 provides a left-side view of the composter assembly 300, shown with the top hatch in an open configuration, according to an example embodiment. The lid assembly 1102 comprises the removable hopper assembly 802. That is, when the lid assembly 1102 is open, both the first lid 304, the second lid 302, and the hopper assembly 802 form the top hatch to open and close as a unit. Opening the top hatch allows users to gain direct access to the compost chambers. The dual-chamber embodiment can be seen in FIG. 13 which provides a top perspective view of the composting apparatus 300 in which a portion of the top hatch is open to allow for viewing a portion of the interior of the apparatus 300. In this embodiment, the compost chambers 1304A and 1304B are directly accessible to a user. The crushing assembly 1302 crushes and/or dewaters the waste/food received from the hopper assembly 802. Together, the crushing assembly 1302 and the hopper assembly 802 form the crushing hopper assembly which were previously shown as assemblies 104a, 104b, 407a, 407b in previous embodiments. Each of the compost chambers 1304A and 1304B is removeable for cleaning or maintenance.

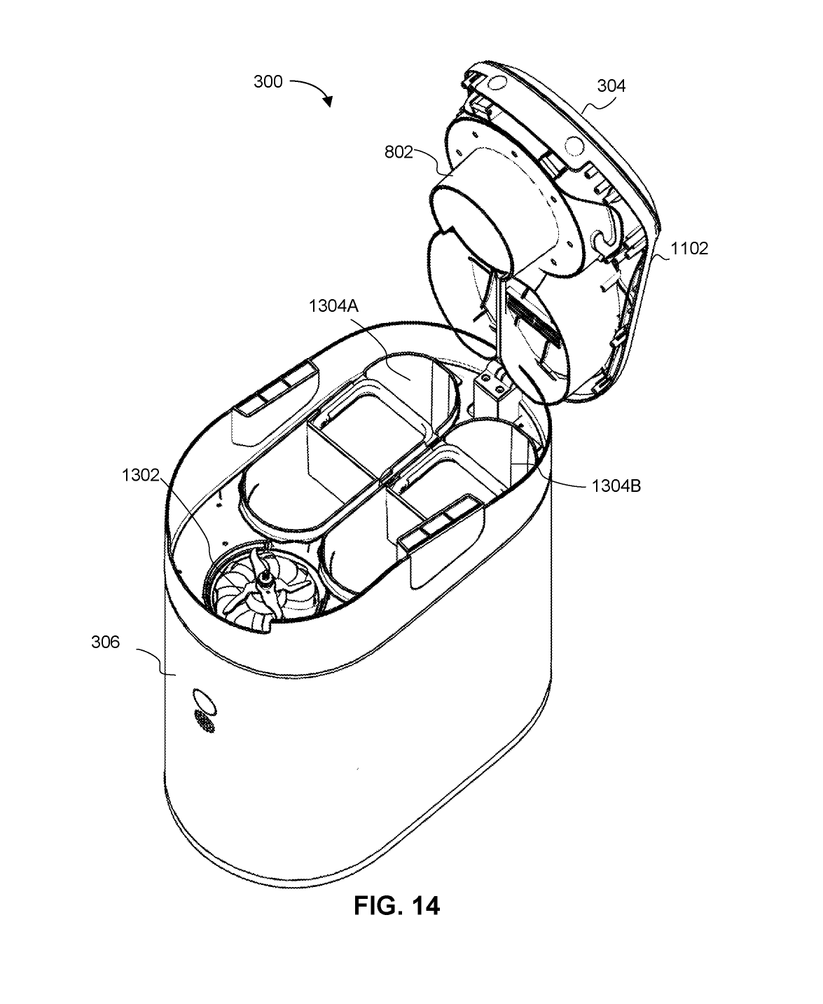

FIG. 14 provides a top-perspective view of the composter assembly 300. In this view, the compost chambers 1304A and 1304B which were previously removed are reinserted into the respective compost chamber cavities. Couplers and adaptors can be implemented on the compost chamber and compost chamber cavity, as described in some previous embodiments, such that the couplers can removably engage the adaptors in a controlled and predictable manner so that once the compost chamber can be reinserted into a compost chamber cavity without an effect on functionality.

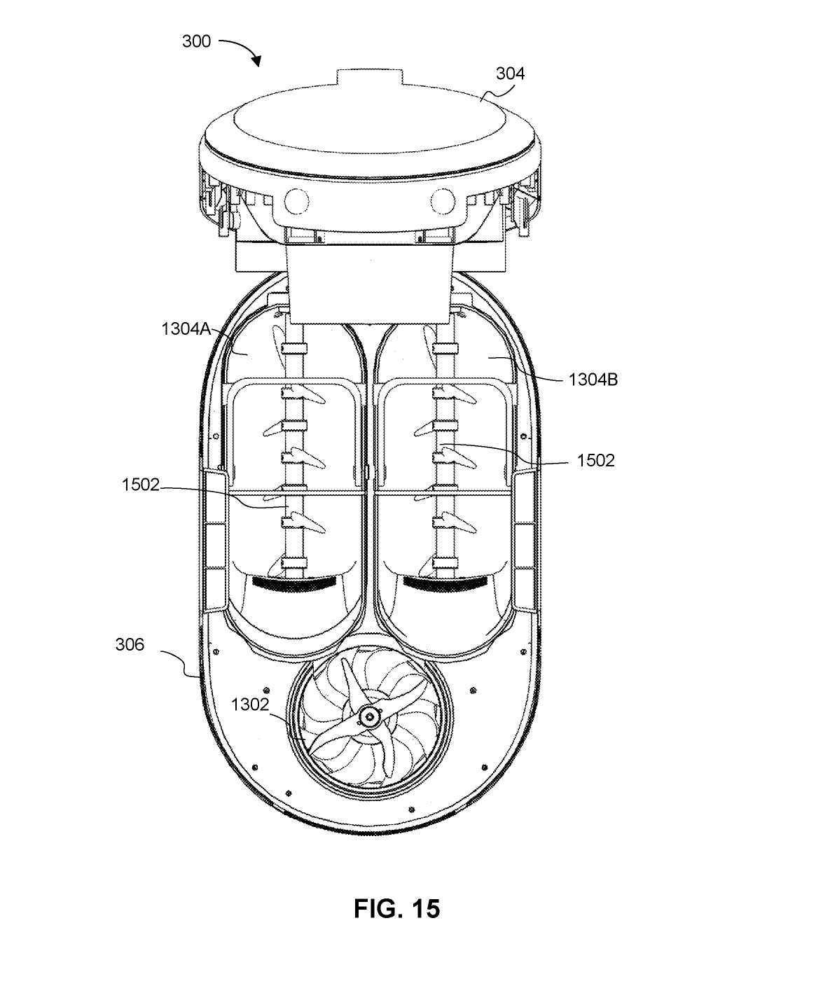

FIG. 15 provides a top-plan view of the composter assembly 300, according to an example embodiment. In this view, the impellers 1502 are visible within the compost chambers 1304A and 1304B.

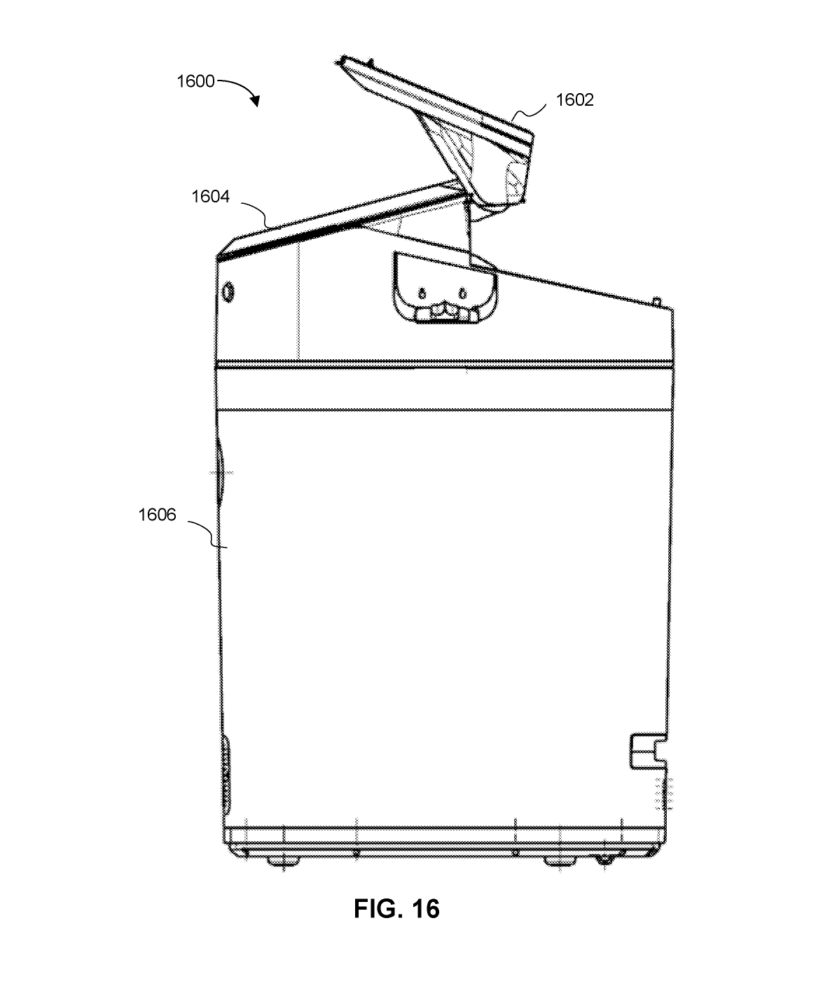

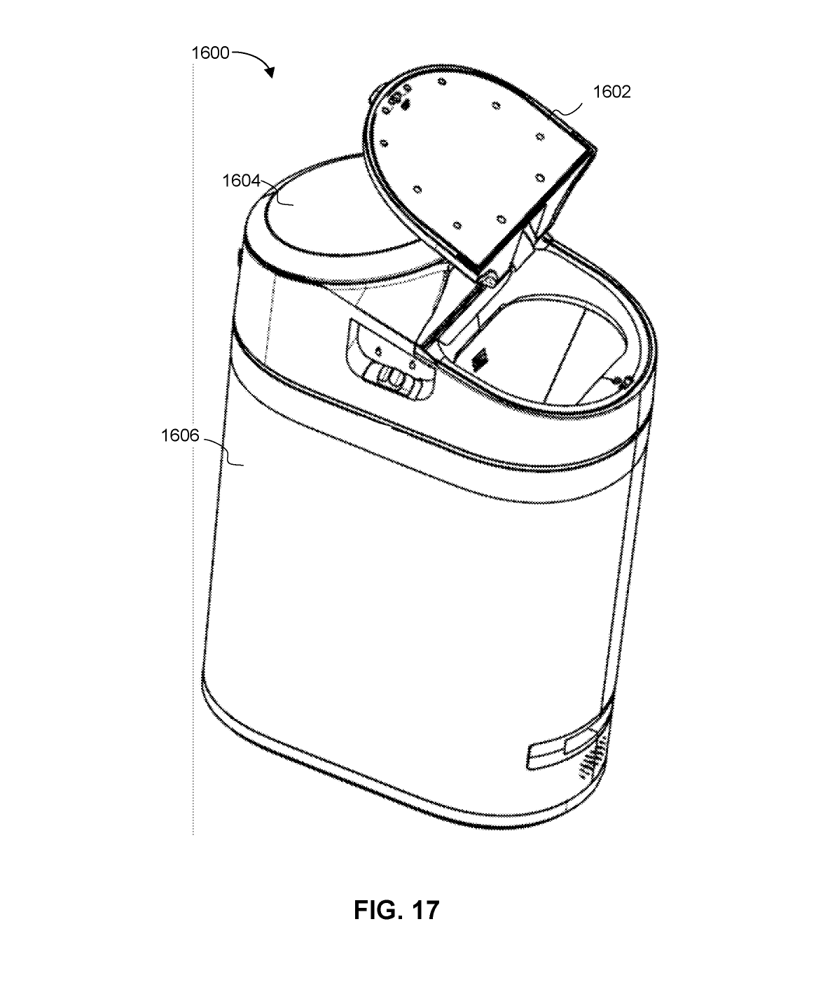

Referring now to FIGS. 16 to 24, shown therein is an example of an alternative embodiment of a composting apparatus 1600 having a dual lid system. Referring now to FIG. 16, shown therein is a left-side view of the composting apparatus 1600. In this embodiment, the composting apparatus 1600 includes: a main device body 1606 (e.g., housing), a first lid 1604 and a second lid 1602. The first and second lids 1602 and 1604 can be located anywhere along the main device body 1606 as long as the location provides access to processing pathways that are described below. However, for ease of use, the first and second lids 1602 and 1604 can be located on the top of the main device body 1606.

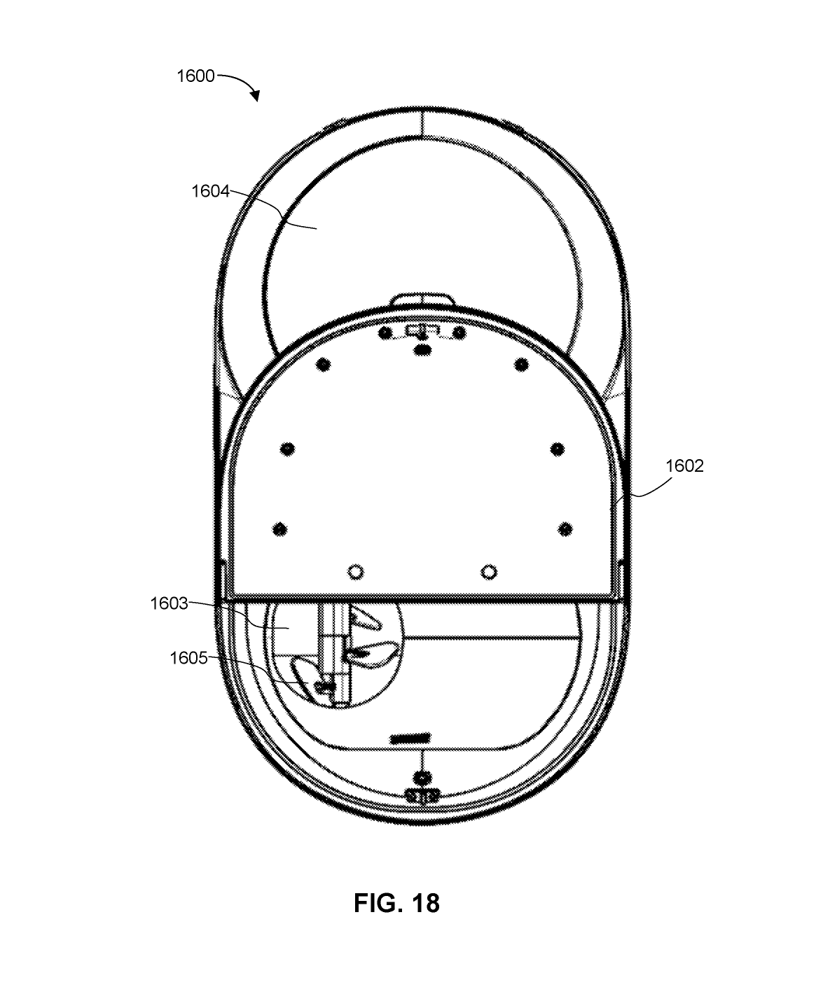

FIG. 17 provides a top perspective view of the composter assembly 1600. In this view, the first lid 1604 is visible, and can be accessed at the front of the device 1600. The second lid 1602 is shown in an open configuration and can be accessed at the rear of the device 1600. In at least one embodiment, the first and second lids 1602, 1604 can be attached to the body 1616 of the composter via a hinge mechanism or sliding mechanism that allows for easy opening and closing. In at least one embodiment, the lids 1602, 1604 can be motorized for actuation by a processor, such as processor 216 for example.

FIG. 18 provides a top plan view of the composter assembly 160016. The second lid 1602 is shown in an open configuration. From the top view, it can be seen that the impellers 1605 located in the compost chamber are directly accessible by aperture 1603. Waste inserted when the second lid 1602 is opened bypasses the crushing assembly and is routed directly to the compost chamber via the aperture 1603. This is useful for waste materials that do not need mechanical processing, such as soft or pre-chopped food scraps.

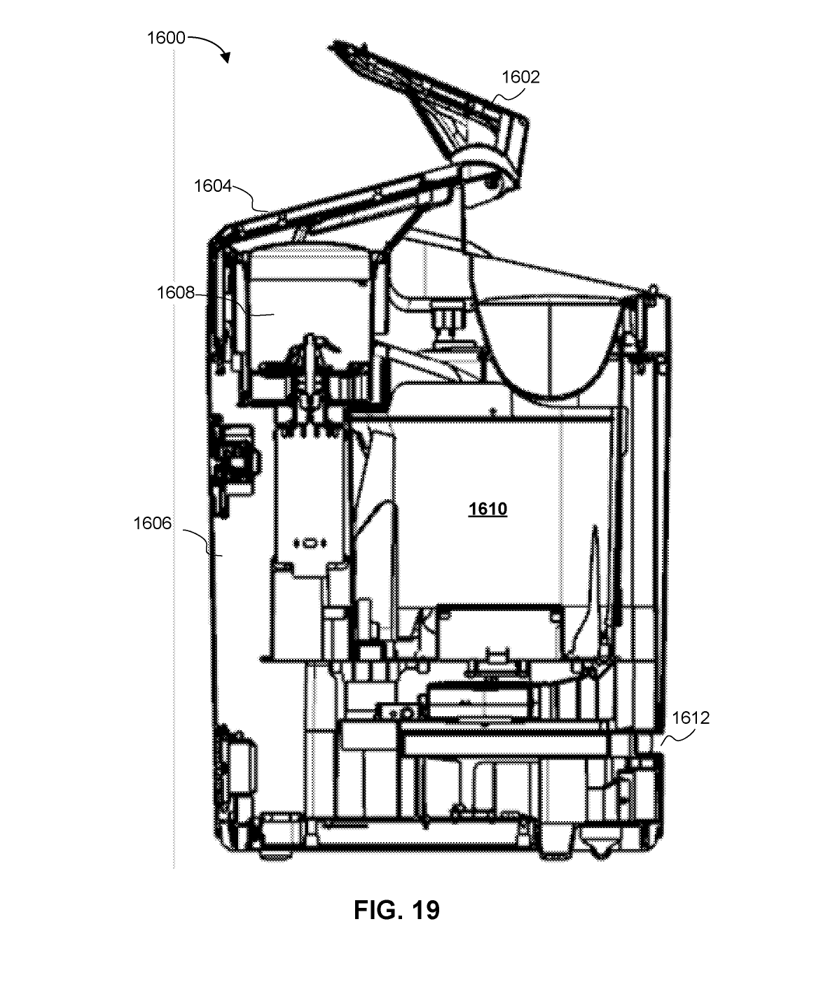

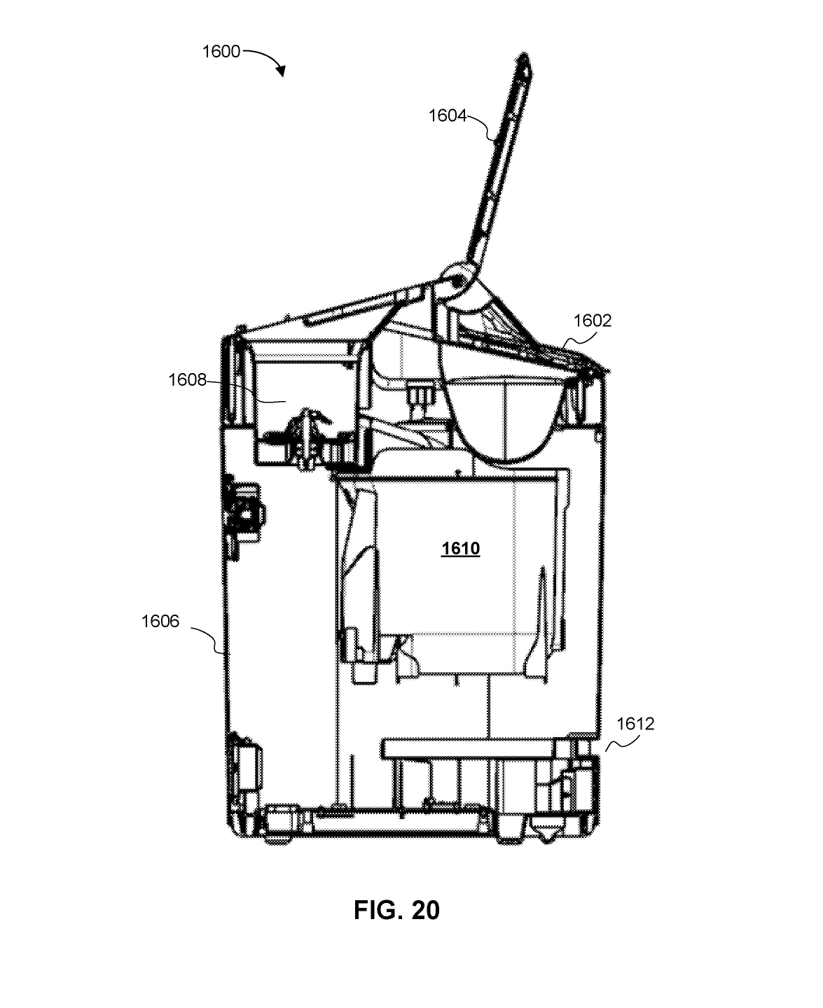

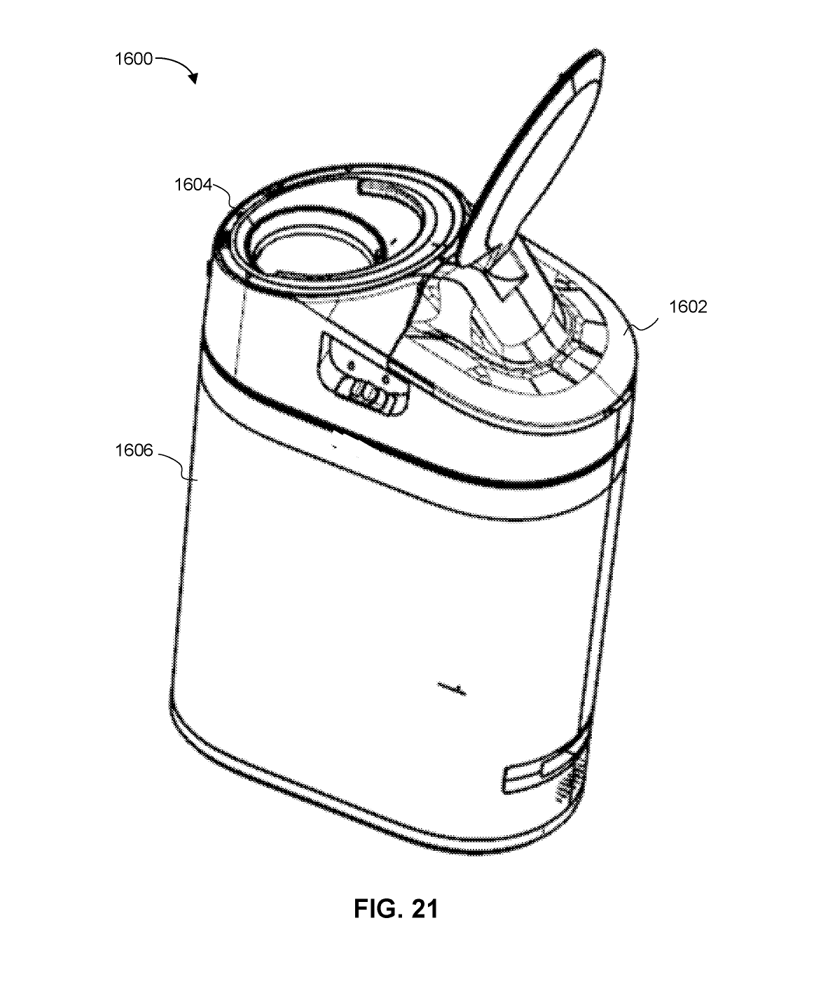

FIGS. 19 and 20 are left-side cross-sectional views of the composter assembly 1600. In FIG. 19, the second lid 1602 is shown in an open configuration, and the first lid 1604 is shown in a closed configuration. In FIG. 20, the second lid 1602 is shown in a closed configuration, and the first lid 1604 is shown in an open configuration.

The composting apparatus 1600 may include: at least one compost chamber 1610 located within the main device body 1606, and a first crushing hopper assembly 1608 connected the at least one compost chamber 1610. The crushing hopper assembly 1608 may be accessible by the first lid 1604. The at least one compost chamber 1610 may be directly accessible by the second lid 1602. The composting apparatus 1600 may further include an airflow and filtration assembly 1612, which can be fluidly coupled to the compost chambers 1610.

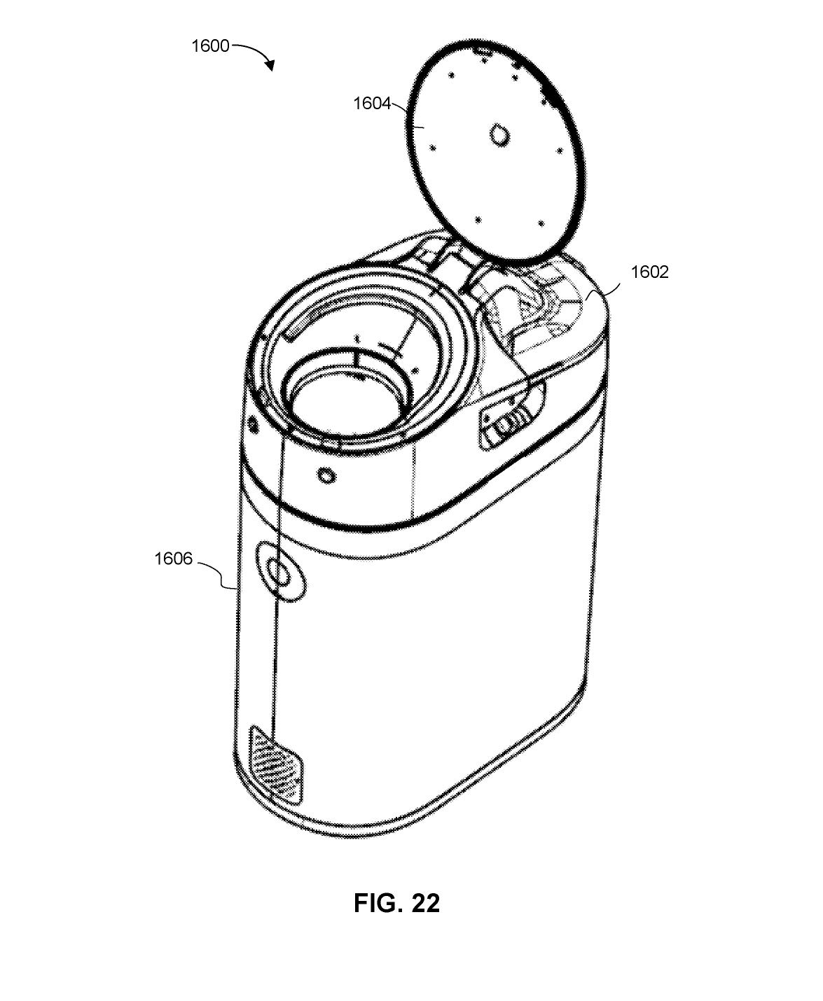

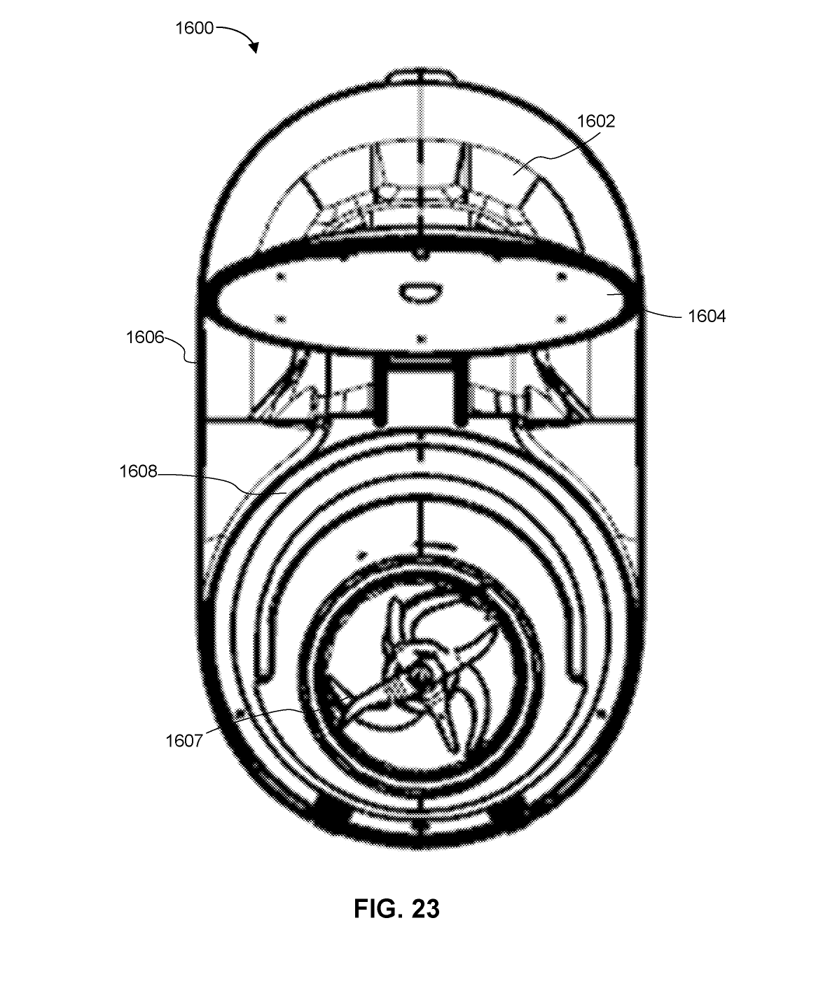

Waste inserted when the first lid 1604 is opened, can be directed into the crushing assembly 1608, consisting of rotary blades, grinders, or crushers powered by an electric motor. The crushing assembly 1608 is designed to reduce the size of the waste material for faster composting. On the other hand, waste inserted when the second lid 1602 is opened bypasses the crushing assembly 1608 and is routed directly to the compost chamber 1610. FIG. 21 is a top-perspective view of the composter assembly shown 1600, showing an open configuration of the first lid 1604. FIG. 22 is a front-perspective view of the composter assembly 1600, showing an open configuration of the first lid 1604.

FIG. 23 is a top-plan view of the composter assembly 1600, showing an open configuration of the first lid 1604. The crushing assembly 1608 comprises a hopper for receiving food waste at a first upper end of the assembly and may include a chopping assembly 1607 at a second lower end of the assembly, opposite the first end. When food waste is collected into the hopper, it reaches the chopping assembly 1607, where the food waste becomes chopped, and/or reduced in particle size. In at least one embodiment, the chopping assembly 1607 may comprise rotating blades, grinders, mashers, crushers or any other suitable means of reducing the particle size and volume of food waste. Once the food waste has undergone a reduction in particle size by the chopping assembly 1607, the processed food waste can optionally enter a dewatering assembly. Alternatively, once the food waste has undergone a reduction in particle size by the chopping assembly 1607, the processed food waste can enter the compost chamber 1610.

The composting apparatus 1600 further comprises a plurality of lids moveable between several positions such as a first position and a second position. The first position of the first lid 1604 covers the crushing assembly 1608, and the second position of the first lid 1604 uncovers crushing assembly 1608, allowing food to be inserted into the hopper. The first position of the second lid 1602 covers the compost chamber 1610, and the second position of the second lid 1602 uncovers compost chamber 1610, allowing food to be inserted directly into the compost chamber 1610. A processor, such as processor 216, can be communicatively coupled to an actuator to actuate/move the lids 1602, 1604 between the first and second positions.

In another embodiment, the lids 1602 and 1604 may be biased to be shut at all times, and open under control by the processor 216 or a user switch (not shown). In such embodiments, the compost chamber 1610 and the crushing assembly 1608 are covered by separately controllable lids of the lid assembly. In some embodiments, the lids could be motorized to open, for example with servo motors with encoders controlling the position of the lids.

The processor 216 can be configured to determine whether crushing of the food is required first, and accordingly actuate the appropriate lids to move between the first and second positions. The processor 216 can also be configured to determine which of the compost chamber(s) is most suitable for the input waste, and accordingly actuate a dam to move between the first and second positions. For instance, in one example, the user may wish to input waste into the composting apparatus 1600. The processor 216 can be configured to determine whether the input waste needs to be milled. In this case, the processor 216 may generate and send a control signal to control an actuator (not shown) to actuate the first lid 1604 to move to the second position to uncover the crushing assembly 1608, and prohibit the waste from directly entering the compost chamber. Subsequently, if the user again inputs waste into the composting apparatus 1600, the processor 2176 can be configured to determine that the input waste does not need to be milled, and will generate and send a control signal to open the second lid 1602 for the user.

In the case that there are multiple compost chambers, a dam can be provided to block and unblock the correct compost chamber based on the processor’s determination. In this embodiment, the processor selection criteria may be based on one or more reasons or criteria, including but not limited to, at least one of the plurality of compost chambers being full, at least one of the plurality of compost chambers being unable to accept further waste, at least one of the plurality of compost chambers being in an inoperable state, at least one of the plurality of compost chambers being currently used, at least one of the plurality of compost chambers being in the middle of a composting sequence, and any other reason that may improve the efficiency of the composting device.

In at least one embodiment, at least one of the various composting apparatuses described herein may be implemented to have various form-factors to accommodate different user needs. For example, the composting apparatus can be a stand-alone unit that may be placed in a pull-out cabinet, under the sink, on a counter-top or on the floor. For the under-sink embodiment, the composting apparatus may be optionally connected directly to the sink or to the drainage pipe inside the sink cabinet. Accordingly, in at least one embodiment, the adaptors 202 may include, but are not limited to, for example, drain connectors, sink connectors, and/or dishwashing connectors and the adaptors 202 may have electrical connectors (e.g., wires) for connection to the power source of the dishwasher.

In another aspect, the composting apparatuses and methods described in accordance with the teachings herein may be used in food-preparation environments such as coffee shops and/or juice shops. In such cases, some of the crushing steps are typically already performed before waste, such as coffee grounds, are provided to the composting apparatus. In these cases, such waste can be provided directly to the compost chamber, via the second lid as described previously. In this case, an input chamber of the composting apparatus may be connected to the waste output of a commercial coffee machine or a juicing machine via existing external fluidic couplers such as a ground waste output of a coffee machine or a pulp waste output of a juicer, or the composting apparatus may include a hopper that can be accessed by users who may transfer coffee grounds from coffee machines or waste from a juicing machine into the composting apparatus. In both cases, the crushing process may be skipped, since the input waste is already crushed, and the composting process may start with aeration, mixing, and optional heating and water spraying. To collect the output compost, depending on the embodiment, users may scoop the output compost out of the composting apparatus, remove the compost chamber as if it was a drawer, or, if the compost is transferred into a compost storage chamber that is removeable, pull out the compost storage chamber. Also, in such cases the composting apparatus may be coupled to existing external electrical connectors of the food-preparation environment.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A dual lid system for a composting device, comprising:
a first lid coupled to a first passageway including a crushing assembly, the first lid being configured to move to an open position to allow incoming waste to enter a crushing hopper assembly of the composting device before being transferred to a compost chamber of the composting device;
a second lid coupled to a second passageway to bypass the crushing assembly, the second lid being configured to move to an open position and allow the incoming waste to bypass the crushing assembly and enter the composting chamber directly; and
a control unit configured to receive a user input from a user or execute a waste detection algorithm to determine which of the first or second lids to open based on a waste type of incoming waste to be processed.

2. The dual lid system of claim 1, wherein the control unit comprises a processor that is communicatively coupled to a memory that stores the waste detection algorithm, wherein the processor is configured to execute the waste detection algorithm to analyze sensor data for the incoming waste to determine one or more characteristics of the incoming waste to determine the waste type which of the first and second lids to open.

3. The dual lid system of claim 2, wherein one or more sensors are included in the dual lid system or are external to the dual lid system, the one or more sensors being operated to obtain the sensor data.

4. The dual lid system of claim 3, wherein the crushing assembly is configured to reduce a size of the incoming waste for faster composting when the first lid is selected.

5. The dual lid system of claim 4, wherein the processor is configured to determine a hardness characteristic of the incoming waste, and generate a control signal to actuate the first lid if the hardness characteristic is higher than a threshold value or actuate the second lid if the hardness characteristic is lower than the threshold value.

6. The dual lid system of claim 5, wherein the sensor data includes any combination of a fill level of the compost chamber, a state of the first lid, a state of a second lid, waste-specific characteristics including any of size, type of incoming waste, moisture content, a weight of the incoming waste, a mass/amount of the incoming waste, a hardness of the incoming waste, and one or more characteristics of existing compost in the compost chamber.

7. The dual lid system of claim 6, wherein when the processor is executing the waste detection algorithm, the processor is configured to use image recognition, weight data from one or more weight sensors or other data points to determine the waste type and determine whether the input waste requires crushing before composting.

8. The dual lid system of claim 7, wherein the system further includes at least one sensor to obtain data on a state of the existing compost in the compost chamber which is used as feedback to the control unit on effectiveness of the crushing.

9. The dual lid system of claim 8, further comprising a user interface that receives the user input to allow the user to manually select which of the first and second lids to open based on the waste type.

10. The dual lid system of claim 9, further including sealing elements/mechanisms to prevent odors from escaping the first and/or second lids during operation.

11. The dual lid system of claim 10, wherein the sealing elements/mechanism provide an airtight seal and optionally include an antibacterial or odor killing component to reduce odors to prevent odor leakage.

12. The dual lid system of claim 11, wherein the first and second lids and/or the sealing element/mechanism are implemented to reduce moisture escape from the composting apparatus.

13. The dual lid system of claim 12, wherein the first and/or second lid is implemented as a condenser to return water droplets back to the crushing assembly and/or compost chamber.

14. The dual lid system of claim 13, wherein the control unit is further configured to adjust the operation of the composting assembly based on whether the input waste was processed through the crushing assembly or directly entered the composting assembly.

15. A method of composting incoming waste by a composting device, the method comprising:
selectively operating a first lid that is coupled to a first passageway including a crushing assembly, the first lid being operated to move to an open position to allow the incoming waste to enter a crushing hopper assembly of the composting device before being transferred to a compost chamber of the composting device;
selectively operating a second lid that is coupled to a second passageway to bypass the crushing assembly, the second lid being operated to move to an open position and allow the incoming waste to bypass the crushing assembly and enter the composting chamber directly; and
generating a control signal using a control unit for operating the first and second lids, wherein the control signal is generated based on a user input from a user or from execution of a waste detection algorithm that selects which of the first or second lids to open based on a waste type of incoming waste to be processed.

16. The method of claim 15, wherein the control unit comprises a processor that is communicatively coupled to a memory that stores the waste detection algorithm, and wherein the method comprises using the processor to:
execute the waste detection algorithm to analyze sensor data for the incoming waste to determine one or more characteristics of the incoming waste; and
determine which of the first and second lids to open based on the waste type.

17. The method of claim 16, further comprising obtaining sensor data from one or more sensors located in the dual lid system or located external to the dual lid system; and wherein the sensor data includes any combination of a fill level of the compost chamber, a state of the first lid, a state of a second lid, waste-specific characteristics including any of size, type of incoming waste, moisture content, a weight of the incoming waste, a mass/amount of the incoming waste, a hardness of the incoming waste, and one or more characteristics of existing compost in the compost chamber.

18. The method of claim 17, further comprising reducing the size of the incoming waste via the crushing assembly for faster composting when the first lid is selected.

19. The method of claim 18, further comprising:
determining, by the processor, a hardness characteristic of the incoming waste;
generating, by the processor, the control signal based on the hardness characteristic; and
actuating the first lid if the hardness characteristic is higher than a threshold value or, actuating the second lid if the hardness characteristic is lower than the threshold value.

20. The method of claim 19, wherein the method further comprises, when the processor is executing the waste detection algorithm, using image recognition and weight data from one or more weight sensors or other data points to determine the waste type and determine whether the input waste requires crushing before composting.
